(19) United States
(12) Patent Application Publication
(10) Pub. No.: US 2011/0004578 A1
(43) Pub. Date: Jan. 6, 2011

(54) ACTIVE METRIC LEARNING DEVICE, ACTIVE METRIC LEARNING METHOD, AND PROGRAM

(76) Inventors: Michinari Momma, Tokyo (JP); Satoshi Morinaga, Tokyo (JP); Norikazu Matsumura, Tokyo (JP); Daisuke Komura, Tokyo (JP)

Correspondence Address: Mr. Jackson Chen, 6535 N. STATE HWY 161, IRVING, TX, 75039, US

(21) Appl. No.: 12/918,832

(22) PCT Filed: Dec. 8, 2008
(86) PCT No.: PCT/JP2008/072229

§ 371 Date: Aug. 23, 2010

(30) Foreign Application Priority Data
Feb. 22, 2008 (JP) 2008-041420

(51) Int. Cl. G06F 15/18

(52) U.S. Cl. 706/12

(57) ABSTRACT

A metric application unit receives data under analysis having a plurality of attributes and a metric indicative of the distance between the data under analysis, calculates the distance between the data under analysis, and output and stores a data analysis result which is generated from an analysis on the data under analysis with a predetermined function, using the calculated distance between the data under analysis. A metric optimization unit generates side-information based on an indication of feedback information entered from the outside and including either similarities between the data under analysis, or the attributes, or a combination thereof, generates a metric which complies with a predetermined condition, based on the generated side information, and stores the generated metric in a metric learning result storage unit.

### TECHNICAL FIELD

The present invention relates to a metric learning device, a metric learning method, and a program which use side-information from a user.

### BACKGROUND ART

A variety of techniques have been proposed for learning a distance metric between data using side-information entered by a user.

For example, as described in E. Xing and A. Ng and M. Jordan and S. Russell, “Distance metric learning, with application to clustering with side-information,” Proceedings of the Conference on Advance in Neural Information Processing Systems, 2003 (Document 1), a distance metric learning method has been contemplated for performing clustering using side-information.

Also, as disclosed in K. Q. Weinberger, J. Blitzer, L. K. Saul “Distance Metric Learning for Large Margin Nearest Neighbor Classification, Proceedings of the Conference on Advance in Neural Information Processing System,” 2006 (Document 2), a distance metric learning method has been contemplated for making a learning to identify data of interest similar to predetermined data based on a circular area centered at the predetermined data. This distance metric learning method involves defining within the circular area a concentric area having a smaller radius than the circular area, identifying data of interest included in the concentric area, and further changing the radius of the concentric area in accordance with the position of the identified data of interest.

Further, as disclosed in J. Davis, B. Kulis, P. Jain, S. Sra, I. Dhillon, “Information-Theoretic Metric Learning,” Proceedings of the 24th International COnference on Machine Learning,” 2007 (Document 3), a distance metric learning method has been contemplated for performing a metric learning based on a class of distance function (for example, Mahalanobis distance) and a multi-variate Gaussian function.

The learning related to such a distance metric belongs to one field of machine learning, and involves receiving side-information from a user along with learning data that are learned by a metric learning device, and outputting a co-variant matrix which includes a correlation of attribute spaces required in the calculation of the distance. The side-information used in Documents 1 to 3 refers to information indicative of degree of association which is the degree to which data or attributes relate to one another. In other words, the metric learning device optimizes a co-variant matrix so as to satisfy the distance between entered data, based on user information related to the distance between data.

The learning of a distance using side-information entered by a user is useful in data analysis by machine learning for learning a distance using a machine. This is attributable to the following reasons.

(1) Optimization of attributes: The learning of the distance between data includes the learning of data expression. The learning of data expression as used herein refers to learning of attributes inherent to the data, and is one of the most important processes in the data analysis.

(2) Acquisition of user knowledge: Knowledge can be readily introduced from a user. In other words, the knowledge can be reflected at a lower cost (for example, a processing cost).

(1) The reason described in (1) relates to optimization of data expression and attributes. A data analysis requires an expression suited for a predetermined purpose. Since the predetermined purpose can be arbitrarily selected by a user, the introduction of knowledge from the user (i.e., entry of information) is indispensable for the generation and optimization of attributes. By introducing the knowledge from the user into adjustment of the distance between data, expression of an attribute space can be simultaneously optimized. However, when data is analyzed based on a data expression (attributes or the like) to which the user's knowledge is not reflected, a result which is unpredictable and is not desired by the user, may be can be delivered, thus possibly failing to satisfactorily achieve the predetermined purpose.

(2) The reason described in (2) relates to the acquisition of the user's knowledge. The user's knowledge, as described herein, has a variety of forms, but can be classified into absolute user knowledge and relative user knowledge.

The “absolute user knowledge” refers, for example, to a label that defines a class to which data belongs.

The “relative user knowledge” refers, for example, to the distance between data or relevance between data. The relative user knowledge may be often defined by assigning thereto a label which is absolute user knowledge. This will be explained below, by way of example, by taking for example a case in which a plurality of document files on a web is classified. Since an arbitrary method may be employed for assigning a label, a label for a document file may have to be replaced with (changed to) another one in some cases. Furthermore, in ranking (for example, assigning a “degree of importance” that relatively defines whether or not a document file is important), a relation can be readily defined between two data items. However, an absolute ranking method cannot be simply applied to the metric learning in some cases because the degree of importance of each analysis target which is recognized by a user must be sometimes identified.

On the other hand, a relative relationship between respective data can often be readily identified. When a label is complete information, a relationship between a plurality of data can be regarded as an incomplete label (incomplete information), so that understanding of the relationship by the user may understand incomplete. For example, such incomplete information can be readily identified by detecting a clicking operation on a web by a user, analysis of data on consumption trend, and the like.

Metric learning using active learning is also popularly performed. Active learning involves prompting a user to select important data, and performing a metric learning using the results of queries entered by the user for issuing a variety of instructions. In general, the active learning acquires queries related to label information of data from the user to execute learning operations with the least possible labels. Active learning often find application in labeled data which entail a high processing cost, such as classification of texts, classification of molecules for use in chemicals, and the like. A variety of forms have been proposed for an index indicative of the degree of importance for such data with high processing cost.

For example, as disclosed in JP2004-021590A, a system has been proposed in which the active learning is applied to learning of a support vector machine. With this system, the active learning is performed by a support vector machine using correct answer cases recorded in a correct answer case database, and classifies the data based on the result of the active learning. The progress of the active learning in this system depends on the form of queries. Here, the queries are not limited to requiring a label related to each item of data.

Furthermore, as disclosed in H. Raghavan, O. Madani, R. Jones, “Active Learning with Feedback on Both Features and Instances,” Journal of Machine Learning Research, 7 Aug., 2006, pp 1655-1686, a system has been proposed for alternately performing attribute selection processing and data classification processing based on the output of queries related to selection of attribute and queries related to label information on data points to provide satisfactorily accurate results while limiting the number of queries.

In the general distance metric learning techniques disclosed in Documents 1 to 3, information used for formulation is limited only to information related to the relevance degree between data, and the rest of information (for example, sets of data, relevance degree between respective sets, information related to attributes, and the like) cannot be entered as information for use in formulation. Consequently, the general distance metric learning techniques disclosed in Documents 1 to 3 suffers from a first problem that there is a possibility that information provided by the user may not be sufficiently made good use of in the course of executing the metric learning.

Further, user interfaces used in the general distance metric learning techniques disclosed in Documents 1 to 3 are not configured so as to place importance on the operability. Consequently, there arises a second problem that when side-information is generated, much expense in time and effort are needed in processing for querying data.

Furthermore, the general distance metric learning techniques disclosed in Documents 1 to 3 lack a capability of selecting important information from a large amount of data. As such, when there is a large amount of data to be analyzed, side-information must be retrieved for each item of data to be analyzed. Consequently, there arises a third problem important data in data analysis cannot be selected from among data to be analyzed, thus failing to improve operation efficiency.

### DISCLOSURE OF THE INVENTION

It is an object of the present invention to provide an active metric learning device, an active metric learning method, and a program, which solve the aforementioned problems.

To solve the above problems, an active metric learning device of the present invention comprises a metric applied data analysis unit including a metric application unit for receiving data under analysis having a plurality of attributes and a metric for calculating the distance between the data under analysis to calculate the distance between the data under analysis, a data analysis unit for analyzing the data under analysis with a predetermined function using the distance between the data under analysis calculated by the metric application unit, and outputting a data analysis result generated through the analysis, and an analysis result storage unit for storing the data analysis result generated by the data analysis unit, and a metric optimization unit including a feedback conversion unit for generating side-information which presents information required for metric learning, based on instructions indicated by feedback information entered from the outside, the feedback information including either similarities between the data under analysis stored in the analysis result storage unit or the attributes, or a combination thereof, and a metric learning unit for generating a metric that complies with a predetermined condition based on the side-information generated by the feedback conversion unit, and storing the generated metric in a metric learning result storage unit. The active metric learning device is characterized in that the metric application unit calculates the distance between the data under analysis using the metric stored in the metric learning result storage unit.

To solve the problems mentioned above, the present invention also provides an active metric learning method which comprises metric applied data analysis processing including metric application processing for receiving data under analysis having a plurality of attributes and a metric for calculating the distance between the data under analysis to calculate the distance between the data under analysis, data analysis processing for analyzing the data under analysis with a predetermined function using the distance between the data under analysis calculated by the metric application processing, and outputting a data analysis result generated through the analysis, and analysis result storage processing for storing the data analysis result generated by the data analysis processing, and metric optimization processing including feedback conversion processing for generating side-information which presents information required for metric learning, based on instructions indicated by feedback information entered from the outside, the feedback information including either similarities between the data under analysis stored through the analysis result storage processing or the attributes, or a combination thereof, and metric learning processing for generating a metric that complies with a predetermined condition based on the side-information generated by the feedback conversion processing operation, and storing the generated metric through a metric learning result storage processing. The active metric learning method is characterized in that the metric application processing operation calculates the distance between the data under analysis using the metric stored through the metric learning result storage processing.

The present invention also provides a program for causing a computer to execute a metric applied data analysis procedure including a metric application procedure for receiving data under analysis having a plurality of attributes and a metric for calculating the distance between the data under analysis, a data analysis procedure for analyzing the data under analysis with a predetermined function using the distance between the data under analysis calculated in the metric application procedure, and outputting a data analysis result generated through the analysis, and an analysis result storage procedure for storing the data analysis result generated in the data analysis procedure, and a metric optimization procedure including a feedback conversion procedure for generating side-information which presents information required for metric learning, based on instructions indicated by feedback information entered from the outside, the feedback information including either similarities between the data under analysis stored through the analysis result storage procedure or the attributes, or a combination thereof, and a metric learning procedure for generating a metric that complies with a predetermined condition based on the side-information generated in the feedback conversion procedure, and storing the generated metric through a metric learning result storage procedure. The program is characterized in that the metric application procedure calculates the distance between the data under analysis using the metric stored through the metric learning result storage procedure.

According to the present invention, data under analysis having a plurality of attributes, and a metric for calculating the distance between the data under analysis are provided as inputs, to calculate the distance between the data under analysis. The data under analysis are analyzed with a predetermined function using the calculated distance between the data under analysis. A data analysis result generated by the analysis is output, and the output data under analysis is stored. Side-information required for metric learning is generated based on indications provided by feedback information entered from outside, which is comprised of either similarities between stored data under analysis, or the attributes, or a combination thereof. A metric which meets a predetermined condition is generated based on the generated side information, the generated metric is stored, and the distance between the data under analysis is calculated using the stored metric. Accordingly, the present invention can process more diverse side-information than general metric learning devices, and can sufficiently utilize information possessed by the user, thus making it possible to alleviate efforts of the user when he generates the side-information, and can improve the efficiency of works by presenting the user with important information extracted from a large amount of data.

### BRIEF DESCRIPTION OF THE DRAWINGS

FIG. 1 is a diagram showing the physical configuration of an active metric learning device according to an embodiment of the present invention.

FIG. 2 is a diagram showing the functional configuration of the active metric learning device according to the embodiment of the present invention.

FIG. 3 is a diagram showing the configuration of a metric applied data analysis unit shown in FIG. 2.

FIG. 4 is a diagram showing the configuration of a metric optimization unit shown in FIG. 2.

FIG. 5 is a diagram showing an exemplary data structure for side-information shown in FIG. 4.

FIG. 6 is a diagram showing the configuration of an active learning unit shown in FIG. 2.

FIG. 7a is a diagram showing an exemplary distribution of a plurality of groups of data under analysis and important data.

FIG. 7b is a diagram showing a first exemplary distribution resulting from a classification of important data into one of a plurality of groups of data under analysis through labeling.

FIG. 7c is a diagram showing a second exemplary distribution resulting from a classification of important data into one of a plurality of groups of data under analysis through labeling.

FIG. 8a is a diagram showing an exemplary distribution of a cluster to which data under analysis belongs and important data.

FIG. 8b is a diagram showing an exemplary area when important data is attached to a cluster through labeling.

FIG. 8c is a diagram showing an exemplary area when important data is not attached to a cluster through labeling.

FIG. 9a a diagram showing an example of an operation for bringing data under analysis closer to each other or an example of an operation for bringing data under analysis further away from each other.

FIG. 9b is a diagram showing an example of an operation for causing a data under analysis to belong to a group or an example of an operation for preventing data under analysis from belonging to a group.

FIG. 10a is a diagram showing an example each of an operation for bringing groups closer to each other or an operation for bringing groups further away from each other.

FIG. 10b is a diagram showing an example of an operation for changing a metric subjected to metric optimization in response to an attribute importance change instruction.

FIG. 11 is a diagram showing an exemplary data structure for a metric map diagram.

FIG. 12 is a flow chart showing operations in a metric learning processing operation.

FIG. 13 is a diagram showing a first example of a data structure for a data analysis map diagram.

FIG. 14 is a diagram showing a second example of the data structure for the data analysis map diagram.

FIG. 15 is a diagram showing a data structure for a metric map diagram when a metric is performed based on the data analysis map diagram shown in FIG. 14.

### BEST MODE FOR CARRYING OUT THE INVENTION

In the following, an active metric learning device (including an active metric learning method and a program) will be described in accordance with an embodiment of the present invention.

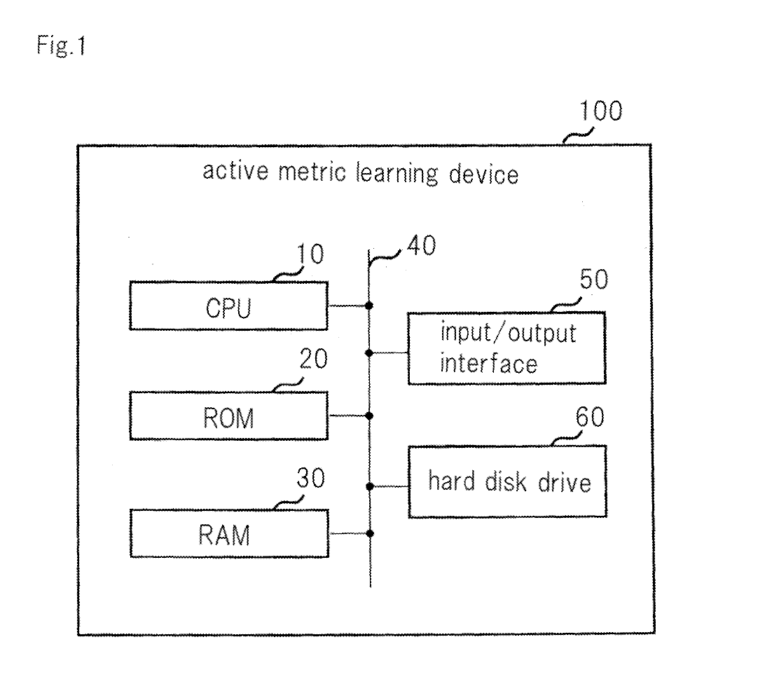

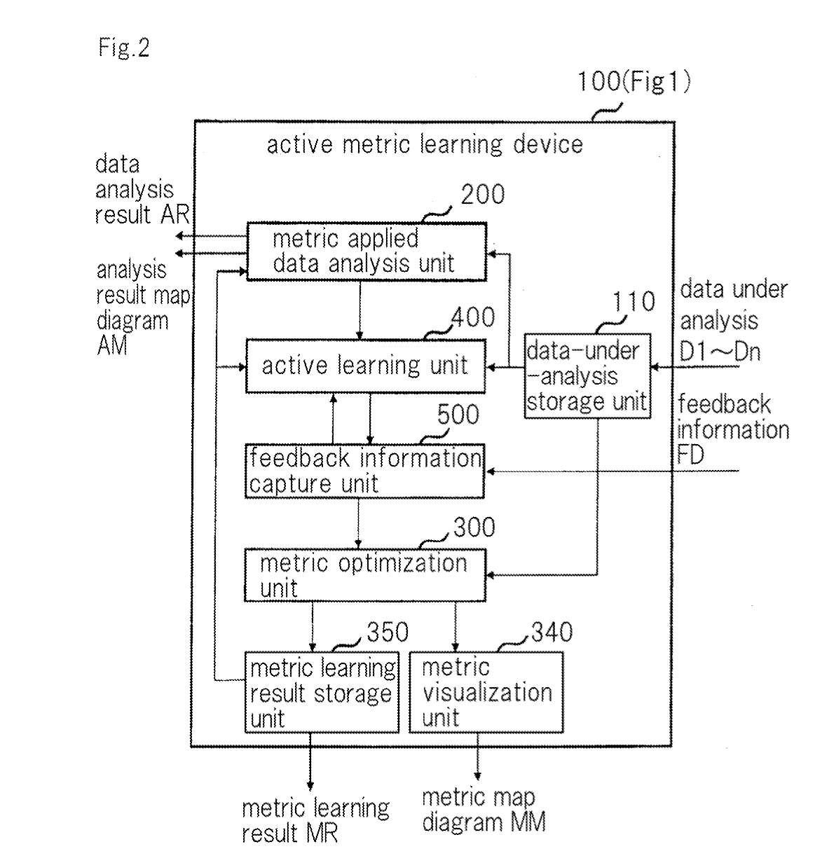

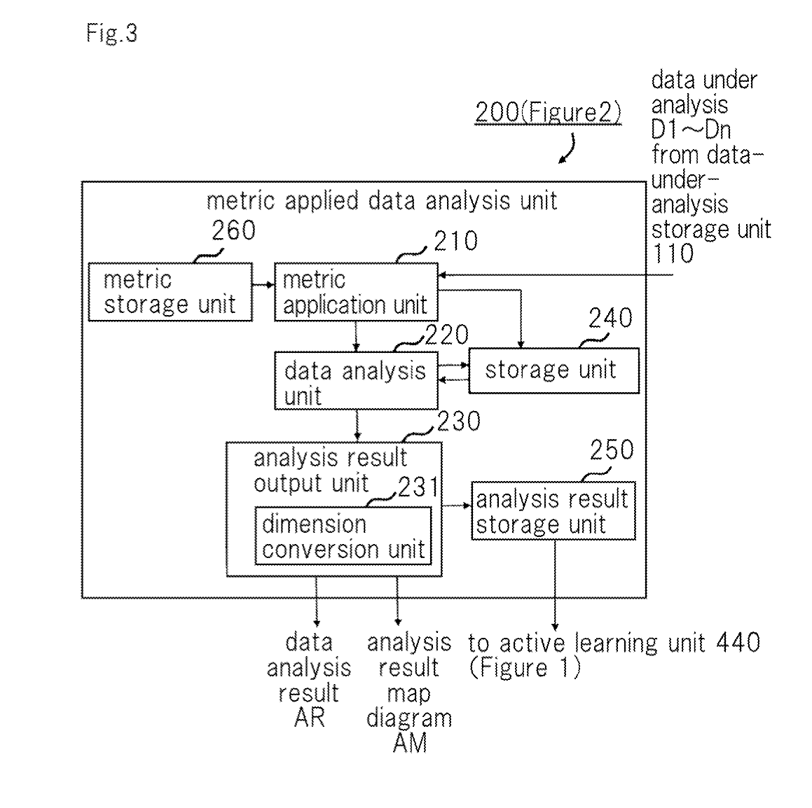

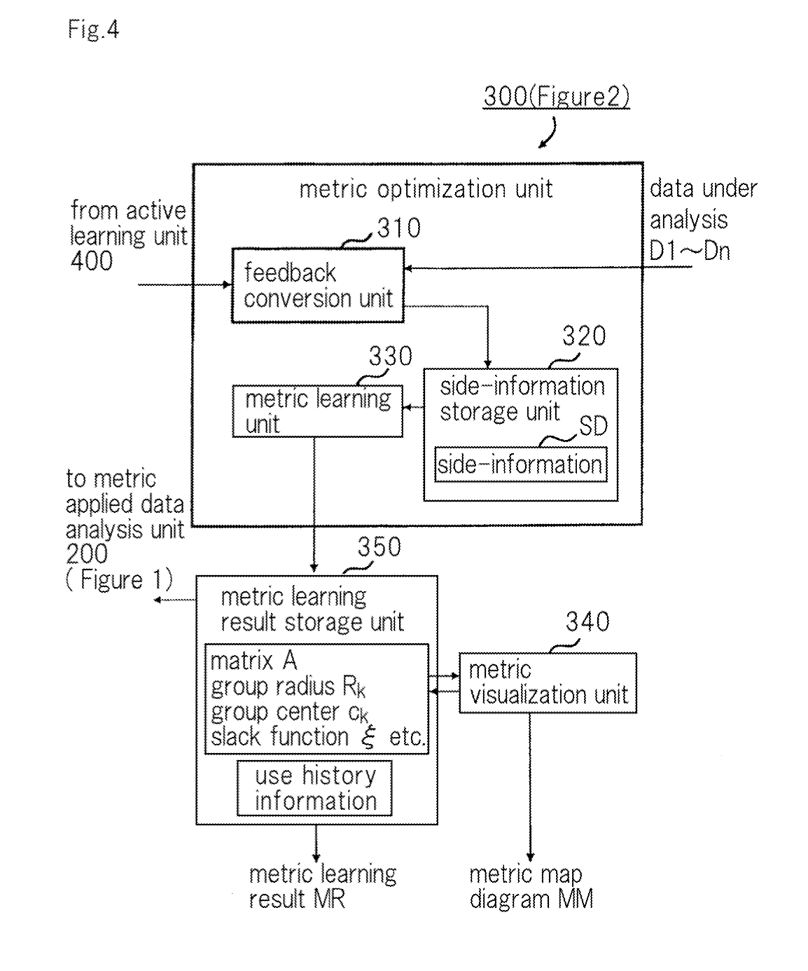

A description will be first given of the physical configuration of an active metric learning device according to an exemplary embodiment. As shown in FIG. 1, active metric learning device 100 comprises CPU (Central Processing Unit) 10, ROM (Read Only Memory) 20, RAM (Random Access Memory) 30, bus 40, input/output interface 50, and hard disk drive 60.

CPU 10 is constituted by a microprocessor unit or the like, and controls the entire active metric learning device 100. CPU 10 executes a variety of processing, for example, in accordance with a program stored in ROM 20, or a program read from hard disk drive 60 to RAM 30.

ROM 20, which is a memory exclusive to reading, is a non-volatile memory for maintaining information stored therein even if the power is off. ROM 20 stores, for example, a program and the like for causing active metric learning device 100 to execute active metric learning operations.

RAM 30, which is a volatile memory, stores as appropriate data required by CPU 10 to execute a variety of processing operations, and the like. RAM 30 also functions as a working memory for CPU 10 to perform operations.

Bus 40 interconnects the respective components.

Input/output interface 50 is an interface that receives data entered from the outside of active metric learning device 100, and outputs data to the outside of active metric learning device 100, and the like. Input/output interface 50 is connected, for example, to a keyboard, a mouse, a display device (for example, a display), a speaker, a network adapter and the like, and functions as metric visualization unit 340 or feedback information capture unit 500, later described.

Hard disk drive 60 is a disk device capable of storing a large capacity of data. Hard disk drive 60 is not limited to the disk device, but may be any device which can read data to a predetermined storage medium, such as a DVD drive.

Hard disk drive 60 functions as metric storage unit 260, analysis result storage unit 250, side-information storage unit 320, and metric learning result storage unit 350, later described.

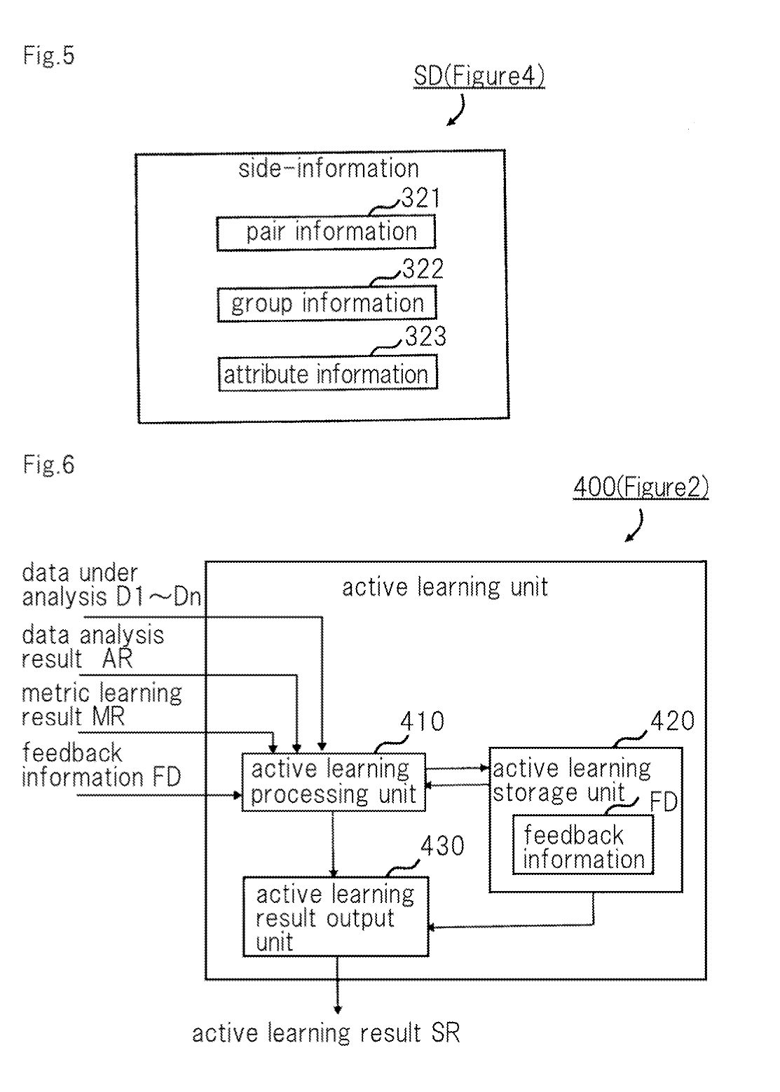

Next, a description will be given of the functional configuration of active metric learning device 100 of this exemplary embodiment. As shown in FIG. 2, active metric learning device 100 comprises data-under-analysis storage unit 110, metric applied data analysis unit 200, metric optimization unit 300, active learning unit 400, and feedback information capture unit 500.

Each component 110, 200, 300, 400, and 500 is interconnected through bus 40 shown in FIG. 1.

Analysis data storage unit 110 is implemented using RAM 30 shown in FIG. 1, and stores data under analysis D1 to Dn entered from the outside.

Metric applied data analysis unit 200 is implemented by CPU 10, RAM 30, and input/output interface 50, shown in FIG. 1.

Metric applied data analysis unit 200 executes “metric applied data analysis processing” to analyze data under analysis D1 to Dn stored in analysis data storage unit 110, and generates “data analysis result AR” which is the result of the data analysis. Metric applied data analysis unit 200 also outputs data analysis result AR and “analysis result map diagram AM,” later described.

In this exemplary embodiment, assume that “data under analysis D1 to Dn” includes n data with the number of attributes being n. In the following description, an i-th (where i:=any of 1 to n) data under analysis is represented by Di.

“Analysis result map diagram AM,” refers to a diagram which shows data analysis result AR generated by metric applied data analysis unit 200, which is mapped to a lower dimensional space, and is used for the user to recognize data analysis result AR.

When data under analysis D1 to Dn have not been entered and have not undergone metric learning, the user enters an initial metric (an initial value for starting a metric). This initial metric may be selected from among data defined by default. Metric applied data analysis unit 200 starts the execution of “metric applied data analysis processing” based on the entered initial metric. As defined by the following Equation 1, the metric may be applied to any arbitrary data which give the distance.

[Equation 1]

d(xᵢ,xⱼ)=φ(xᵢ,xⱼ) (1)

where j is a function which gives the distance between two data xᵢ and xⱼ. In this exemplary embodiment, the aforementioned data under analysis D1 to Dn are applied as each data xᵢ, xⱼ. Data xᵢ, xⱼ (data under analysis D1 to Dn) which serve as arguments of function j may be a value or a symbol. The following description will be given of an example where a distance is represented by matrix A (metric parameters) which represents weights or correlations among attributes. In this case, distance d(xᵢ, xⱼ) between data xᵢ, xⱼ is given by the following Equation 2:

[Equation 2]

d(xᵢ,xⱼ)=(xᵢ−xⱼ)^{T}A(xᵢ−xⱼ) (2)

Each data xᵢ, xⱼ in distance d(xᵢ, xⱼ) defined by Equation 2, is a vector which has a real value. Matrix A is a transform matrix that defines the importance for attributes or the association among the respective attributes, and is a “positive semi-definite value matrix,” the eigenvalues of which are all non-negative (zero or positive). As such, when a unit matrix is selected as an initial value, this is equivalent to the fact that all weights are determined to be “1” for the attributes and the correlation are determined to be “0” between the respective attributes.

Specifically, metric applied data analysis unit 200 calculates the distance between the data under analysis based on the product of the metric parameters (matrix A) subjected to the metric, and the difference between data xᵢ, xⱼ under analysis for which the distance is to be calculated.

Next, the configuration of “metric applied data analysis unit 200” will be described in detail.

As shown in FIG. 3, metric applied data analysis unit 200 comprises metric application unit 210, data analysis unit 220, analysis result output unit 230, storage unit 240, analysis result storage unit 250, and metric storage unit 260.

Metric application unit 210 executes “metric application processing”. That is, metric application unit 210 applies the metric to data under analysis D1 to Dn, and provides data analysis unit 220 with data resulting from the metric (for example, values after the metric) based on data under analysis D1 to Dn. Here, the term “metric” refers to an operation for applying a “predetermined function” to data under analysis D1 to Dn to determine a predetermined value (for example, the distance between two data items under analysis).

No particular limitations are imposed on the “predetermined function” for use in applying the metric. For example, a primary transform may be applied to data under analysis D1 to Dn. In this case, a matrix (for example, LU transform that resolves matrix A into the product of a lower triangular matrix and a upper triangular matrix, a square root of the matrix) that satisfies the relation: A=B′B is used for transformation of xᵢ′=Bxᵢ. Alternatively, the distance may be calculated, for example, based on the aforementioned Equation 2.

Data analysis unit 220 executes “data analysis processing” to analyze data defined by metric application unit 210. Here, no limitations are imposed on a data analysis method. Further, a problem under analysis, treated by data analysis unit 220, is arbitrary as long as it is a problem for analyzing data based on the distance between respective data xᵢ, xⱼ. For example, a classification problem, a recursion problem, clustering, a ranking problem and the like may be subjected to the analysis.

Analysis result output unit 230 executes “analysis result output processing” to supply a file or an external display device (not shown) with data analysis result AR indicative of the analysis result by data analysis unit 220, and analysis result map diagram AM generated based on data analysis result AR.

This “analysis result map diagram AM” can be displayed for detailed information, for example, through operations of a keyboard, a mouse or the like connected to input/output interface 50. The user can generate feedback information FD that is entered into feedback information capture unit 500 based on analysis result map diagram AM.

Analysis result output unit 230 also comprises dimension conversion unit 231. This dimension conversion unit 231 executes “dimension conversion processing” to convert the dimensions of elements included in data analysis result AR such that data analysis result AR generated by data analysis unit 220 is mapped to a lower dimension space, when analysis result map AM is generated.

Here, no limitations are imposed on a method by which dimension conversion unit 231 converts the dimensions. For example, when converting the dimensions, dimension conversion unit 231 may employ a “singular value resolution” that resolves a matrix which is comprised of real or composite elements (real elements in the example for description). Further, when the singular value resolution is employed, a restrictive condition may be set up to bring the dimensions of the elements closer to the conversion result achieved by the dimension conversion which has been executed immediately before.

Alternatively, dimension conversion unit 231 may employ, for example, a “non-negative matrix resolution” which results in a base matrix that includes no negative elements when it converts the dimensions. Further, when the non-negative matrix resolution is used, a restrictive condition may be set up to bring the dimensions of the elements closer to the conversion result achieved by the dimension conversion which has been executed immediately before.

Analysis result output unit 230 has functions of visualizing, for example, a class or a cluster to which each data item under analysis Di belongs, and displaying on an external display device (not shown) attributes or the like which characterize original data, class, or cluster from data points. While this display device is not a component essential to metric learning device 100, but it may be provided in metric learning device 100. Also, the display device may comprise a touch panel function. In this alternative, the display device also serves to enter a variety of data in response to operations of the user performed thereon.

Storage unit 240 stores a variety of data. For example, storage unit 240 stores the result derived by applying the metric to data under analysis D1 to Dn by metric application unit 210. Data analysis unit 220 reads the result after the application of the metric, stored in storage unit 240.

Analysis result storage unit 250 stores data analysis result AR which is the result of an analysis made by data analysis unit 220.

Metric storage unit 260 stores a variety of data required by metric application unit 210 to execute “metric application processing.” The data as used herein may be, for example, data that defines a predetermined relationship equation (for example, the relationship equation shown by Equation 2) for the metric of data under analysis optimized by metric optimization unit 300.

Next, metric optimization unit 300 will be described.

Metric optimization unit 300 is implemented by CPU 10, RAM 30, input/output interface 50, and hard disk drive 60, which are shown in FIG. 1.

Metric optimization unit 300 captures feedback information FD that is entered through operations performed by the user on feedback information capture unit 500, and data under analysis D1 to Dn, and performs metric learning by optimizing the metric based on captured data under analysis D1 to Dn. After executing the optimization processing operation, metric optimization unit 300 outputs “metric learning result MR” and “metric map diagram MM.”

Here, “metric learning result MR” includes, in addition to the aforementioned matrix A, other information derived by the optimization processing operation.

“Metric map diagram MM,” shows matrix A, which comprises metric parameters, mapped to a lower dimensional space, and is used for the user to recognize the importance of attributes possessed by data under analysis D1 to Dn, the relevance degree of the attributes, and the like.

Metric map diagram MM can be directly edited by the user. Feedback information capture unit 500 captures feedback information FD through editing.operations of metric map diagram MM, and captured feedback information FD is supplied to metric optimization unit 300.

Metric optimization unit 300 comprises a function of executing “metric learning termination determination processing” to determine whether or not it is instructed to terminate the metric learning.

In the following, a detailed description will be given of components which make up metric optimization unit 300. As shown in FIG. 4, metric optimization unit 300 comprises feedback conversion unit 310, side-information storage unit 320, metric learning unit 330, metric visualization unit 340, and metric learning result storage unit 350.

Feedback conversion unit 310 executes “feedback conversion processing,” to generate “side-information SD” based on feedback information FD that is entered into feedback information capture unit 500.

The term “side-information SD” as used herein refers to information that is required for the metric learning, and which is converted from feedback information FD into a mathematical expression. The reason why “side-information SD” is required for the metric learning is that side-information SD is generated based on knowledge of the user, and that metric learning unit 330 executes the metric learning such that distance d(xᵢ, xⱼ) between data under analysis satisfies conditions indicated by side-information SD.

Side-information storage unit 320 stores side-information SD that is generated by feedback conversion unit 310 based on feedback information FD.

In the following, this “side information SD” will be described in detail.

As shown in FIG. 5, side-information SD is classified by type into pair information 321 indicative of mutual similarity between data under analysis D1 to Dn, group information 322 indicative of each group to which respective data under analysis belongs, and attribute information 323 indicative of attributes of data under analysis which belongs to each group. Representation of feedback information FD entered by the user is transformed by combining these items of side-information SD.

For example, assume that in a cluster analysis, the user enters feedback information FD which indicates that a predetermined cluster is not needed into feedback information capture unit 500.

Operations which can be selected by active metric learning device 100 based on this feedback information FD correspond, for example, to an operation for deleting data within the cluster, an operation for increasing the variance of the cluster, an operation for reducing the importance of an attribute indicative of a feature of the cluster, and the like. In this case, active metric learning device 100 cannot uniquely determine operations performed thereby based on entered feedback information FD (corresponding to the fact that a mathematical interpretation is not uniquely determined). In other words, operations which should be executed by active metric learning device 100 based on entered feedback information FD vary depending on data set (data under analysis D1 to Dn) and a problem (an object desired by the user through data analysis).

To avoid such a problem, feedback conversion unit 310 converts feedback information FD entered by the user into information (side-information SD) indicative of a mathematical expression which uniquely identifies the operation of active metric learning device 100 in response to feedback information FD.

Metric learning unit 330 executes “metric learning processing” to perform a “metric learning” which is processing for optimizing the metric (a predetermined relationship equation for the metric of data under analysis). Metric learning unit 330 reads side-information SD stored in side-information storage unit 320, and optimizes parameters included in a distance metric as determined variables so as to satisfy conditions defined by side-information SD. For example, when distance d(xᵢ, xⱼ) is defined by the relationship represented by Equation 2, metric learning unit 330 executes a processing operation such that distance d(xᵢ, xⱼ) satisfies the conditions indicated by side-information SD, by changing elements within matrix A which includes metric parameters.

While there are a variety of forms of side-information SD, active metric learning device 100 of the present invention utilizes, in addition to a general relationship of data pairs, as side-information SD, information related to the distance between a set of data (group) under analysis and the data under analysis, and information related to the relevance degree (similarity) between data sets (groups).

After the processing operation has been completed, metric learning unit 330 outputs, in addition to modified “matrix A.”, values of “group radius Rₖ”, “group center cₖ”, and “slack function ξ”, later described, and the like.

A detailed description will be given later of an approach for metric learning unit 330 to calculate “group radius Rₖ” and “group center cₖ”.

Metric visualization unit 340 executes “metric visualization processing” to display a metric parameter (for example, matrix A) on a display device (not shown). When the metric parameter is represented by matrix A, this metric parameter is projected onto a higher dimensional space. For this reason, a general method such as dimension reduction is employed to calculate a metric parameter which is mapped to lower dimensions, and metric visualization unit 340 generates metric map diagram MM for illustrating the metric parameter which is mapped to a lower dimensional space.

The user can recognize the metric parameter (for example, matrix A) learned by metric optimization unit 300 in metric learning device 100, by referencing to this metric map diagram MM.

Active metric learning device 100 is also provided with a user interface (feedback information capture unit 500, later described) for allowing the user to add new restrictive conditions to a metric parameter represented by metric map diagram MM which is being displayed by metric visualization unit 340. Thus, the user can simply add new restrictive conditions to the metric parameter represented by metric map diagram MM through this user interface when metric learning result MR differs from the learning result desired by the user.

Metric learning result storage unit 350 executes a “metric learning result storage process” to store the values of matrix A, group radius Rₖ, group center cₖ, and slack function ξ and the like calculated by metric learning unit 330 through its processing. Metric learning result storage unit 350 also stores “use history information” indicative of use history when the user has continuously utilized metric learning device 100.

Next, the configuration of active learning unit 400 will be described in detail.

Active learning unit 400 is implemented by CPU 10, RAM 30, and input/output interface 50, which are shown in FIG. 1.

Active learning unit 400 extracts “important data IM” which is important data likely to affect data analysis result AR, from among data analysis result AR provided by metric applied data analysis unit 200 or data under analysis D1 to Dn.

Active learning unit 400 further ranks extracted important data IM. This ranking method may be a general ranking method, for example, for assigning an importance degree to important data IM. Active learning unit 400 also comprises a function of determining, through “active learning enable/disable determination processing,” whether or not active learning should be executed during the metric learning.

Here, “important data IM” extracted by active learning unit 400 refers to data which causes a significant change in the progress of data analysis (result of data analysis in the course of the data analysis) in accordance with the value of important data IM, and is a “correlated attribute.” No particular limitations are imposed on the type of important data IM. Details on important data IM will be described later.

As shown in FIG. 6, active learning unit 400 comprises active learning processing unit 410, active learning storage unit 420, and active learning result output unit 430.

Active learning processing unit 410 executes “active learning processing” to actively learn the metric during data analysis. Active learning processing unit 410 also generates “active learning result SR” which is the result of active learning executed thereby. Here, learning operations performed by active learning processing unit 410 may be, for example, an operation for extracting the aforementioned important data IM from among data under analysis D1 to Dn, an operation for ranking extracted important data IM, and the like.

Specifically, active learning processing unit 410 executes “active learning processing” based on data analysis result AR retrieved from analysis result storage unit 250, metric learning result MR retrieved from metric learning result storage unit 350, data under analysis D1 to Dn captured from the outside, and feedback information FD captured by feedback information capture unit 500. Active learning processing unit 410 also learns data under analysis which is located at a “predetermined position based on the interval between data under analysis” (for example, on a separation plane of a class or a cluster, or the like), and stores learned active learning result SR in active learning storage unit 420.

An arbitrary identification method may be employed by active learning processing unit 410 to identify a “correlated attribute (important data IM).” For example, a correlated attribute may be identified based on a “correlation coefficient” which is a statistic index indicative of the correlation between two variables (degree of similarity).

Alternatively, active learning processing unit 410 may identify a correlated attribute, for example, based on a “collocation score” indicative of the frequency.

Further alternatively, active learning processing unit 410 may identify a correlated attribute, for example, based on mutual information amount, or may identify a correlated attribute based on a conditioned probability.

Active learning storage unit 420 stores, through the execution of an “active learning storage process,” active learning result SR by active learning processing unit 410 (for example, important data IM extracted by active learning processing unit 410 or the like) and feedback information FD.

Active learning result output unit 430 executes an “active learning result output processing” to output active learning result SR (for example, important data IM, importance degree of each important data IM) generated by active learning processing unit 410 through the “active learning processing.” Here, no particular limitations are imposed on a form in which the active learning result is output. For example, the active learning result may be displayed on an external display device (not shown), written into a file, or the like.

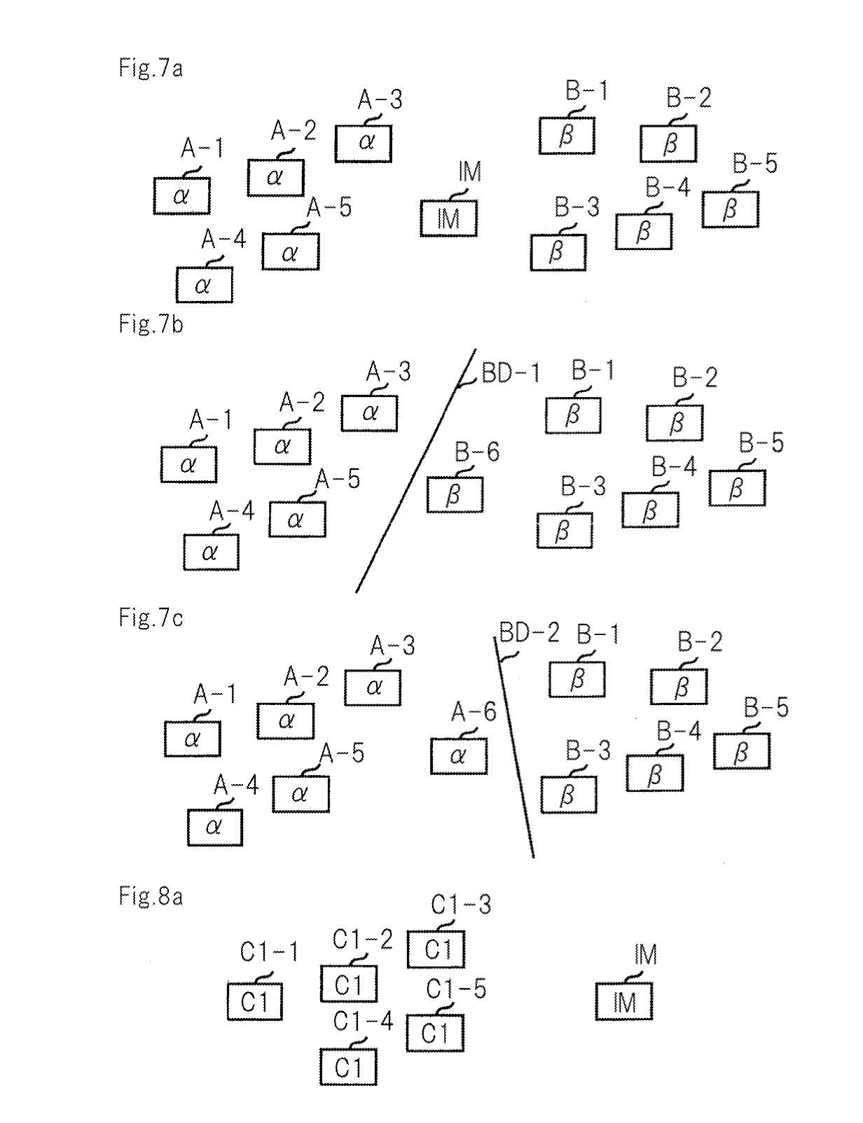

In the following, a more specific description will be given of “important data IM” which is extracted by active learning processing unit 410. As a first example, a description will be given of a classification problem, taken as an example, for determining boundary BD along which data under analysis A-1 to A-5 and B-1 to B-5 extracted as samples from a plurality (two in this example) of different classes (class a and class b) are respectively classified in accordance with classes a, b to which each data item under analysis belongs, as shown in FIG. 7a. When labeling is performed such that important data IM shown in FIG. 7a is designated as data B-6 which belongs to class b, the boundary between class a and class b is determined boundary BD-1 shown in FIG. 7b. On the other hand, when labeling is performed such that important data IM shown in FIG. 7a is designated as data A-6 which belongs to class a, the boundary between class a and class b is determined boundary BD-2 shown in FIG. 7c. Thus, the result of the labeling for important data IM significantly affects the result of data analysis (boundary).

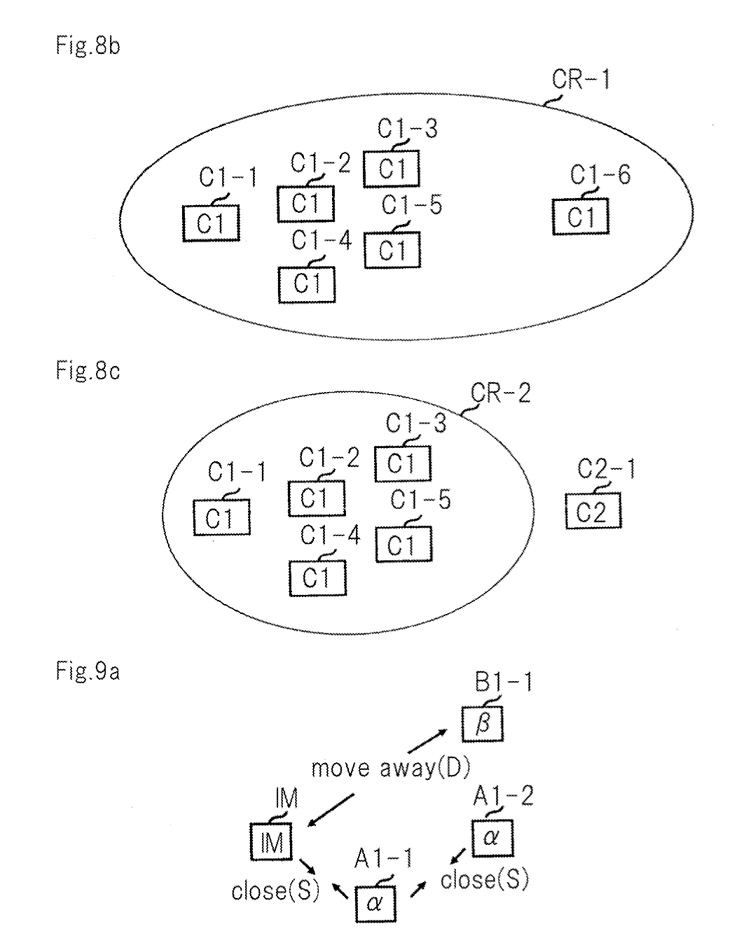

Another description will be given of clustering shown in FIG. 8a, taken as a second example, for determining a region in which data under analysis exist and which belong to a predetermined cluster. Like the classification problem described above, in the clustering as well, the result of data analysis (region) largely depends on the result of the labeling for important data IM. Specifically, when labeling is performed such that important data IM shown in FIG. 8a is designated as data C1-6 which belongs to cluster C1, the region of cluster C1 is determined to be region CR-1 shown in FIG. 8b. On the other hand, when labeling is performed such that important data IM shown in FIG. 8a is designated as data C2-1 which belongs to cluster C2, the region of cluster C1 is determined to be region CR-2 shown in FIG. 8c, which largely differs from region CR-1.

Next, feedback information capture unit 500 will be described.

Feedback information capture unit 500 is implemented using input/output interface 50, and a keyboard (not shown) or the like connected to input/output interface 50, which are shown in FIG. 1.

Feedback information capture unit 500 executes a “feedback information capture process” to capture feedback information FD in accordance with an input operation performed by the user, and delivers feedback information FD to feedback conversion unit 310 and active learning processing unit 410. Feedback information capture unit 500 may be configured to include a variety of input devices (for example, a keyboard, a mouse, a touch panel and the like) for receiving operations from the user. Feedback information capture unit 500 also comprises a function of determining the presence/absence of feedback information FD entered by the user by executing a “feedback presence/absence determination processing.”

Next, a detailed description will be given of “side-information SD” generated by feedback conversion unit 310 of metric learning device 100 which is configured as described above.

Most basic side-information SD used in general metric learning techniques indicates whether the distance between a pair of data item is long or short. In this case, when metric learning device 100 is supplied with information, as feedback information FD, indicative of whether or not a large number of data under analysis D1 to Dn belong to the same cluster, an optimization problem will increase in scale (for example, the number of procedures which are to be executed when the problem is solved). More specifically, the number of pairs as side-information SD will increase to a value approximately two power of the number n of all data under analysis D1 to Dn.

To avoid such a problem, in metric learning device 100 of the present invention, metric learning unit 330 handles at least part of data under analysis D1 to Dn as a one aggregated group, and specifies a condition in which the group has a small radius (hereinafter called the “group belonging condition”).

Stated another way, the “group belonging condition” states that there is a small distance from group center cₖ to each data under analysis which belongs to the group. It is to be noted that if a cluster is not labeled, a group does not match with a cluster in some cases. The case where a group does not match with a cluster refers, for example, to a case where a plurality of groups belongs to the same cluster.

Metric learning device 100 of the present invention introduces the concept of “group center cₖ” and “group radius Rₖ” which is the distance from group center cₖ in handling data xᵢ, xⱼ (corresponding to data under analysis D1 to Dn). Thus, it is possible to specify a condition in which predetermined data does not belong to a predetermined group (hereinafter called the “group exclusion condition”).

Further, in metric learning device 100 of the present invention, metric learning unit 330 can establish a relationship between groups (for example, how large the distance is between respective groups) using group radius Rₖ and group center cₖ.

When the distance between group centers cₖ is short, the distance between group centers cₖ possessed by the respective groups is smaller than the sum of group radii Rₖ possessed by the respective groups. On the other hand, when group centers cₖ are far away from each other, the distance between group centers cₖ possessed by the respective groups is larger than the sum of group radii Rₖ possessed by the respective groups. Metric learning unit 330 can specify conditions for the importance degree of attributes and the relationship between attributes as well, applied to a data analysis, using group center cₖ and group radius Rₖ.

When “group centers cₖ” and “group radius Rₖ” are introduced, a condition can also be specified in which initial value A₀ is given to a parameter (for example, matrix A represented by Equation 2) for the distance metric, and a value changed from given initial value A₀ is limited within a predetermined range (not so further away from initial value A₀). According to such a method of specifying a condition, matrix A can be regularized. Also, since a small value is involved in the change from initial value A₀ which has been possessed by matrix A, matrix A can be used for initial value A₀ even when a data analysis processing operation is repeatedly executed. In this exemplary embodiment, the aforementioned “group belonging condition,” “group exclusion condition” and the like are taken into consideration in formulating an optimization problem. In this regard, if there are a plurality of conditions which should be specified in processing an optimization problem, a multi-purpose optimization method can be applied to the formulation.

In the following, a more specific description will be given of this multi-purpose optimization method. In this exemplary description, the formulation is performed based on the following Equation 3:

[Equation 3]

min D(A,A₀) s.t. constraints A≧0 (3)

In Equation 3, D(A, A₀) is an amount indicative of the difference between A and A₀, for example, a matrix, a vector norm, Bregman divergence (pseudo-distance generally defined for a vector), or the like. Further, “min” in Equation 3 means “minimize” and indicates that an amount described behind “min” is minimized. Furthermore, “s.t.” in Equation 3 means “subject to” and indicates that constraints described behind “s.t.” (for example, an equation or the like) is a restrictive condition.

For example, when D(A,A₀) is an L1 norm of matrix elements, D(A,A₀) is expressed by the following Equation 4:

$$[ Equation 4 ]$$

$$D ( A , {A}_{0} ) = {\sum }_{i , j = 1}^{n} \vert {A}_{i , j} - {A}_{0 i , j} \vert \qquad ( 4 )$$

Alternatively, when D(A, A₀) is a Burg matrix divergence, for example, D(A,A₀) is expressed by the following Equation 5:

[Equation 5]

D(A,A₀)=trace(A,A₀)−log det(AA₀)−n (5)

Equations 4 and 5 both satisfy the relationship expressed by the following Equation 6:

[Equation 6]

D(A,A)=0 (6)

Minimizing D(A,A₀) is equivalent to a metric parameter (matrix A) which approaches to initial value A₀. In this case, constraints (restrictive conditions) indicated in Equation 3 may take a form of relationship equation which represents a variety of side-information SD, such as the relationship between data under analysis D1 to Dn, the relationship between data groups, and the like, in the form of inequality as the restrictive conditions. The condition expressed by Equation 6 is applied for matrix A to be a positive semi-definite value matrix, and is a condition for defining a correct distance between data.

Since a variety of conditions are included in the restrictive conditions of Equation 3, all inequalities sometimes cannot be satisfied. All inequalities cannot be satisfied when noise components are present, when errors are included in side-information SD, when relationship equations given as the restrictive conditions include relationships which are contradictory to each other, and the like. In such a case, the restrictive conditions can be formulated so as to minimize an unsatisfied amount, as shown in the following Equation 7:

[Equation 7]

min D(A,A₀)+γLoss(constraint violation) s.t. constraints+constraint violation A≧0 (7)

“Loss” shown in Equation 7 is a loss function which applies, for example, a concave function (norm, linear function) or the like. By calculating a weighted linear sum of distance D(A,A₀) and loss function Loss, it is also possible to adjust the proportion of trade-off so as to give a higher priority either to minimize distance D(A,A₀) or to satisfy the restrictive conditions as much as possible.

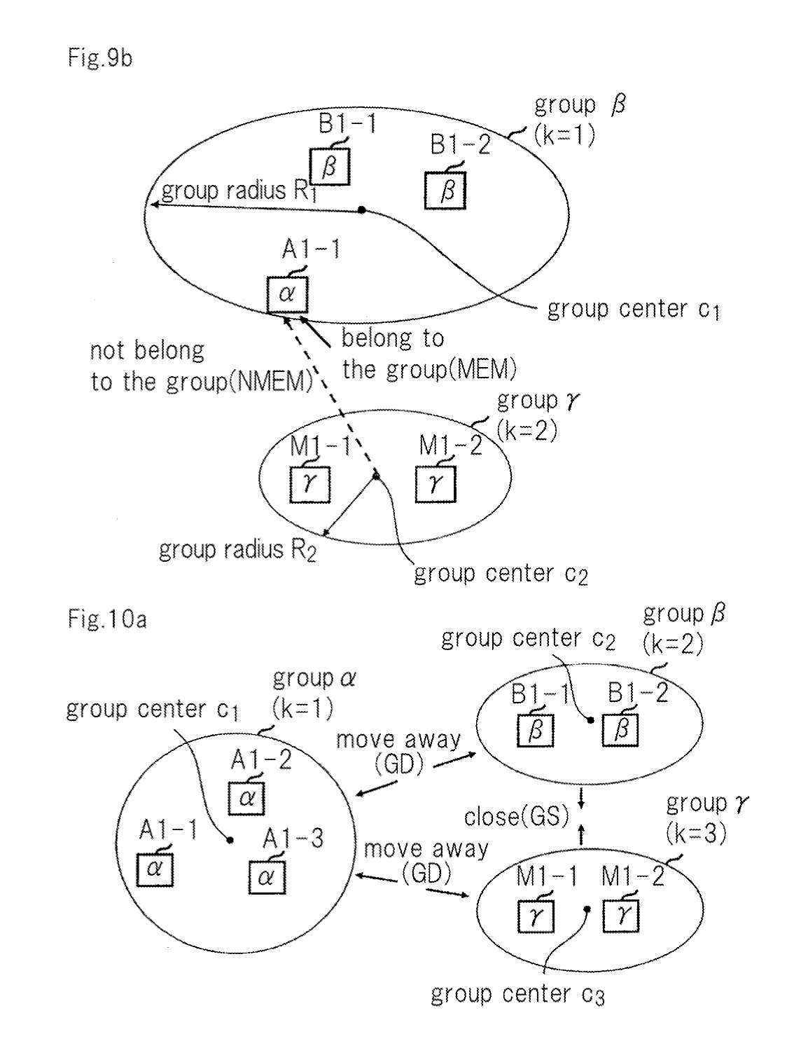

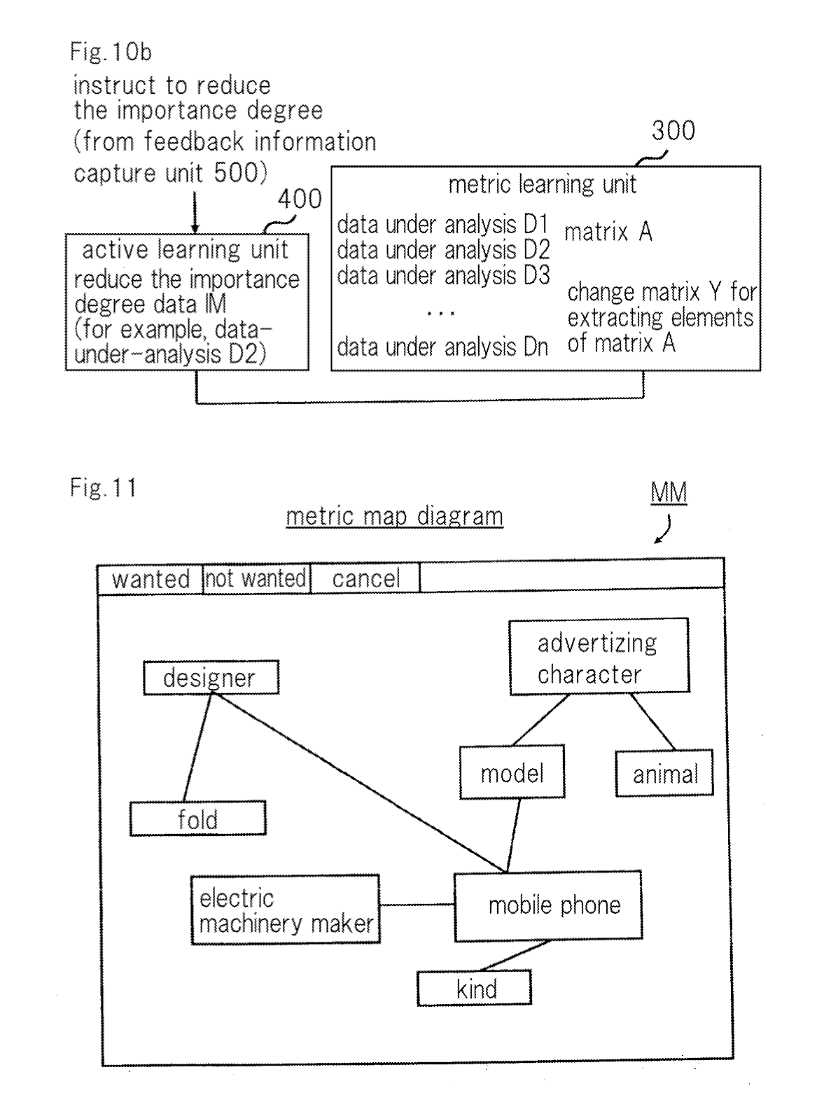

Referring next to FIGS. 9a, 9b and FIGS. 10a, 10b, a detailed description will be given of the formulation of side-information SD.

Inequalities for indicating associations between data shown in FIG. 9a can be expressed by the following Equations 8a and Equation 8b:

[Equation 8]

(xᵢ−xⱼ)^{T}A(xᵢ−xⱼ)≦ξᵢⱼ^{S}(i,j)εS (8a)

(xᵢ−xⱼ)^{T}A(xᵢ−xⱼ)≧ξᵢⱼ^{D}(i,j)εD (8b)

Here, S shown in Equation 8a represents a set of data which are similar to one another and are closely spaced apart from one another. On the other hand, D shown in Equation 8b represents a set of data which are dissimilar to one another and are far spaced apart from one another. Also, εᵢⱼ^{S} shown in Equation 8a represents a slack variable indicative of the degree of errors related to the set S of data similar to one another, while εᵢⱼ^{D} shown in Equation 8b represents a slack variable indicative of the degree of errors related to the set D of data dissimilar to one another. The term “slack variable” refers to a variable which is introduced to detect an extreme feasible point at which an arbitrary number or more of equations are established.

Inequalities for determining whether or not data under analysis a belongs to a group shown in FIG. 9b (group b or g in this example) can be expressed by the following Equations 9a and 9b:

[Equation 9]

(xᵢ−cₖ)^{T}A(xᵢ−cₖ)≦Rₖ²iεGₖ (9a)

(xᵢ−cₖ)^{T}A(xᵢ−cₖ)≧Rₖ²iε G̅ₖ (9b)

In the foregoing Equations 9a and 9b, “cₖ” (k=1 to 2 in this example) refers to the group center of each group k. When data belongs to group k (MEM), the distance from group center cₖ falls within group radius Rₖ, as indicated by Equation 9a. On the other hand, when data does not belong to group k (NMEM), the distance from group center cₖ has a value larger than group radius Rₖ, as indicated by Equation 9b.

The relevance between groups a, b, and g shown in FIG. 10a can be expressed by the following Equations 10:

[Equation 10]

(cₖ−cₗ)^{T}A(cₖ−cₗ)≦Rₖ²+Rₗ²lεS(k) (10a)

(cₖ−cₗ)^{T}A(cₖ−cₗ)≧Rₖ²+Rₗ²lεD(k) (10b)

S(k) shown in the foregoing Equation 10a represents a set of groups close to group k, while D(k) shown in Equation 10b represents a set of groups far from group k.

Further, restrictive conditions in relation to elements of matrix A shown in FIG. 10b are set up by the following Equation 11.

[Equation 11]

trace(AYᵢ)≧ρ^{A} (11)

The left side of Equation 11 finds the sum of eigenvalues included in matrix A. Accordingly, matrix Yᵢ serves to extract each element included in matrix A. By changing matrix Yᵢ based on feedback information FD captured by feedback information capture unit 500 or on important data IM extracted by active learning unit 400, metric learning unit 330 can change the relevance (importance degree of attributes) among the elements of matrix A which is subjected to metric optimization. In this regard, no limitations are imposed on a method of changing matrix Yᵢ. For example, matrix Yᵢ may be changed when so instructed by an external device such as a robot, or matrix Yᵢ may be changed in response to an instruction received through a Web or the like.

Further, a description will be given of the formulation of the aforementioned conditions in Equations 8 to 11 when the conditions are simultaneously optimized.

$$[ Equation 12 ]$$

$$\begin{matrix}min {r}_{0} D ( A , {A}_{0} ) + {r}_{s} {t}_{s} + {r}_{D} {t}_{D} + {r}_{A} {t}_{A} + {\sum }_{k = 1}^{K} ( \begin{matrix}\begin{matrix}{r}_{M} {t}_{M} ( k ) + \\ {r}_{\overline{M}} {t}_{\overline{M}} ( k ) + \\ {r}_{GS} {t}_{GS} ( k ) +\end{matrix} \\ {r}_{GD} {t}_{GD} ( k )\end{matrix} ) \\ s . t . {r}_{S} + {r}_{D} + {r}_{M} + {r}_{A} + {r}_{\overline{M}} + {r}_{GS} + {r}_{GD} = 1 \\ \begin{matrix}{t}_{S} = {C}_{S} {\sum }_{i , j ∈ S} {ξ}_{ij}^{S} & {t}_{D} = {C}_{D} {\sum }_{i , j ∈ D} {ξ}_{ij}^{D} - {ρ}^{D}\end{matrix} \\ {t}_{M} ( k ) = {R}_{k}^{2} + {C}_{{G}_{k}} {\sum }_{i ∈ {G}_{k}} {ξ}_{i}^{{G}_{k}} \\ {t}_{\overline{M}} ( k ) = {C}_{\overline{{G}_{k}}} {\sum }_{i ∈ {\overline{G}}_{k}} {ξ}_{i}^{\overline{{G}_{k}}} - {ρ}^{\overline{{G}_{k}}} \\ {t}_{GS} ( k ) = {C}_{GS} {\sum }_{i ∈ S ( k )} {ξ}_{k 1}^{GS} \\ {t}_{GD} ( k ) = {C}_{GD} {\sum }_{i ∈ GD ( k )} {ξ}_{k 1}^{GD} - {ρ}^{GD} \\ {t}_{A} = {C}_{A} {\sum }_{i} {ξ}_{i}^{A} - {ρ}^{A} \\ \begin{matrix}{z}_{ij}^{T} {Az}_{ij} \leq {ξ}_{ij}^{S} & ( i , j ) ∈ S\end{matrix} & ( 12 a ) \\ \begin{matrix}{z}_{ij}^{T} {Az}_{ij} \geq {ρ}^{D} - {ξ}_{ij}^{D} & ( i , j ) ∈ D\end{matrix} & ( 12 b ) \\ \begin{matrix}{( {x}_{i} - {c}_{k} )}^{T} A ( {x}_{i} - {c}_{k} ) \leq {R}_{k}^{2} + {ξ}_{i}^{Gk} & i ∈ {G}_{k}\end{matrix} & ( 12 c ) \\ \begin{matrix}{( {x}_{i} - {c}_{k} )}^{T} A ( {x}_{i} - {c}_{k} ) \geq {R}_{k}^{2} + {ρ}^{\overline{Gk}} - {ξ}_{i}^{\overline{Gk}} & i ∈ {\overline{G}}_{k}\end{matrix} & ( 12 d ) \\ \begin{matrix}{( {c}_{k} - {c}_{1} )}^{T} A ( {c}_{k} - {c}_{1} ) \leq {R}_{k}^{2} + {R}_{1}^{2} + {ξ}_{k 1}^{GS} & 1 ∈ S ( k )\end{matrix} & ( 12 e ) \\ \begin{matrix}{( {c}_{k} - {c}_{1} )}^{T} A ( {c}_{k} - {c}_{1} ) \geq {R}_{k}^{2} + {R}_{1}^{2} - {ξ}_{k 1}^{GD} + {ρ}^{GD} & 1 ∈ D ( k )\end{matrix} & ( 12 f ) \\ trace ( {AY}_{i} ) \geq {ρ}^{A} - {ξ}_{i} & ( 12 g ) \\ {ξ}^{S} , {ξ}^{D} , {R}_{k}^{2} , {ρ}^{D} , {ξ}^{Gk} , {ξ}^{\overline{Gk}} , {ρ}^{\overline{Gk}} , {ξ}^{GS} , {ξ}^{CD} , {ρ}^{GD} , {ρ}^{A} \geq 0 & ( 12 h )\end{matrix}$$

Here, “r” in Equations 12 is a parameter representative of the importance degree of each condition, and “K” is the number of groups. Metric learning unit 330 calculates optimized matrix A based on the values of the respective parameters mentioned above and side-information SD. Metric learning unit 330 further defines the distance between data (for example, distance d(xᵢ, xⱼ) shown in Equation 2) and the like using the calculated matrix A.

A method for solving the foregoing problem involves one method using a general software application that solves a positive semi-definite value problem. However, such a software-based method is not the best or fastest method for solving a positive semi-definite value problem. Since active metric learning device 100 is configured to place importance on user interactions (entry of feedback information FD), it must be tailored to be capable of more suitably solving a positive semi-definite value problem.

Another method called “sequential minimal optimization”, which is generally employed by SVM (support vector machine) is applied to a simplified version of the positive semi-definite value problem. First, the positive semi-definite value problem is simplified into the following problem:

$$[ Equation 13 ]$$

$$min {D}_{1 d} ( A , {A}_{0} ) - v ρ + {\sum }_{i , j ∈ S} {C}_{ij} {ξ}_{ij}^{S} - {\sum }_{i , j ∈ D} {C}_{ij} {ξ}_{ij}^{D} \\ \begin{matrix}{z}_{ij}^{T} {Az}_{ij} - b \leq - ρ - {ξ}_{ij}^{S} & ( i , j ) ∈ S\end{matrix} \\ \begin{matrix}{z}_{ij}^{T} {Az}_{ij} - b \geq ρ + {ξ}_{ij}^{D} & ( i , j ) ∈ D\end{matrix} \\ {ξ}_{ij} \geq 0 , ρ \geq 0 , A ≽ 0 \qquad ( 13 )$$

The foregoing Equation 13 does not include restrictive conditions related to the relevance degree of groups to one another. But this can be addressed if the equation is modified.

In the following description, the aforementioned subscripts are replaced for purposes of description. Assume that an i-th set refers to a set of (j, k). Also, “label l” is introduced. When an i-th set belongs to D, then the i-th label lᵢ is equal to 1, whereas when it belongs to S, the label lᵢ is equal to −1. Accordingly, metric learning is executed for a problem represented by the following Equation 14:

$$[ Equation 14 ]$$

$$min {D}_{1 d} ( A , {A}_{0} ) - v ρ + {\sum }_{i} {C}_{i} {ξ}_{i} \\ {1}_{i} ( {z}_{i}^{T} {Az}_{i} - b ) \leq ρ - {ξ}_{i} \\ {ξ}_{i} \geq 0 , ρ \geq 0 , A ≽ 0 \qquad ( 14 )$$

Also, a dual problem is given by the following Equation 15:

$$[ Equation 15 ]$$

$$min log det {A}^{- 1} \\ s . t . {A}^{- 1} = {A}_{0}^{- 1} - {\sum }_{i} {α}_{i} {1}_{i} {z}_{i} {z}_{i}^{T} \\ {\sum }_{i}^{m} {α}_{i} \geq v , 0 \leq {α}_{i} \leq {C}_{i} , {\sum }_{i}^{m} {α}_{i} {1}_{i} = 0 \qquad ( 15 )$$

Equation 15 includes “log det” as an objective function. Accordingly, matrix A and inverse matrix A⁻¹ thereof are positive definite value matrixes. Since positive definite value constraints are satisfied by the objective function, a solution corresponding to the dual problem of Equation 15 may be found to satisfy linear restrictive conditions.

In the following, a description will be given of a method of sequentially calculating αᵢ in Equation 15. When αᵢ in Equation 15 is sequentially calculated, αᵢ must be updated so as to satisfy the relationship of Equation 16:

[Equation 16]

Σᵢ₌₁^{m}lᵢαᵢ=0 (16)

Stated another way, not only single element αᵢ but also two elements αᵢ and lᵢ are simultaneously updated. The equation of this update equation is given by the following Equation 17:

[Equation 17]

α^{t+1}=α^{t}+τ(eᵢ−lᵢlⱼeⱼ) (17)

Here, eⱼ in Equation 17 represents a vector having a j-th element, the value of which is “1” and having other elements, the value of which are “0”, and τ represents a step size. When the format shown in Equation 17 is fitted into an update of the dual problem, the problem is expressed by the following Equation 18:

[Equation 18]

A^{-1(t+1)}=A^{-1(t)}τ(zᵢzᵢ^{T}−lᵢlⱼzⱼzⱼ^{T}) (18)

Step size τ should be chosen such that a differentiation of logdetA-^{1(τ+1)} with τ results in zero. In this case, a closed solution is obtained, and step size τ is expressed by the following Equation 19:

$$[ Equation 19 ]$$

$$\hat{τ} = \frac{{21}_{i}}{{z}_{i}^{T} {A}^{( t )} {z}_{i} - {z}_{j}^{T} {A}^{( t )} {z}_{j}} \qquad ( 19 )$$

Further for solving this dual problem, it is necessary to satisfy the restrictive condition shown in Equation 15 (relationship expressed by the following Equation 20):

$$[ Equation 20 ]$$

$${\sum }^{m} {α}_{i} \geq v \qquad ( 20 )$$

In this case, step size τ is expressed by Equation 21 as a conditional relationship equation as follows:

$$[ Equation 21 ]$$

$$τ = \{ \begin{matrix}\hat{τ} & when {1}_{i} = {1}_{j} \\ max ( \hat{τ} , \frac{v - {v}^{t}}{2} ) & otherwise\end{matrix} \qquad ( 21 )$$

From a restrictive condition: 0≦aᵢ≦Cᵢ and the restrictive condition shown in Equation 16, an additional condition is required for updating α. Upper limit value Uᵢ of α and lower limit value Lᵢ of α are expressed by the following Equations 22 when i-th label lᵢ is equal to j-th label lⱼ:

[Equation 22]

Uᵢ=min(Cᵢ,αᵢ^{t}αᵢ^{t}) (22a)

Lᵢ=max(0,αᵢ^{t}+αⱼ^{t}−C) (22b)

Upper limit value Uᵢ of α and lower limit value Lᵢ of α are expressed by the following Equations 23 when the relationship between the i-th and j-th labels is represented by lᵢ≠lⱼ:

[Equation 23]

Uᵢ=min(Cᵢ,αᵢ^{t}−αⱼ^{t}+C) (23a)

Lᵢ=max(0,αᵢ^{t}−αⱼ^{t}) (23b)

An update which satisfies all conditions is expressed by the following Equation 24:

$$[ Equation 24 ]$$

$${α}_{i}^{t + 1} = \{ \begin{matrix}U & when {α}_{i}^{t} + τ > U \\ L & when {α}_{i}^{t} + τ < L \\ {α}_{i}^{t} + τ & otherwise\end{matrix} \qquad ( 24 )$$

When metric learning unit 330 in active metric learning device 100 is caused to execute the aforementioned method, its algorithm is generally defined in the following manner.

(1) α of the initial value is selected to satisfy the restrictive conditions.

(2) A point at which conditions of a main program are not satisfied is selected using heuristic (self-finding learning), and metric parameters are updated with respect to the selected point.

(3) The solution of the main problem is found based on a KKT (Karush-Huhn-Tucker) condition (necessary and sufficient condition for optimality).

In this way, the solutions can be sequentially found for the simplified problem as shown in Equation 14. The problems shown in Equations 12a to 12h may also be solved by, applying a similar method thereto.

The problems shown in Equations 12a to 12h and the problem shown in Equation 14 find such solutions that involve matrix A which is a positive definite value matrix. Generally, however, the solutions tend to increase the processing time for calculating the distance.

To avoid this problem and reduce the processing time, matrix A must be reduced in rank. A description is given below of a method of reducing the rank of matrix A to provide a lower rank matrix. The following Equation 25 represents a dual problem which should be solved when matrix A is reduced in rank:

$$[ Equation 25 ]$$

$$min trace A + {\sum }_{i = 1}^{m} {C}_{i} {ξ}_{i} \\ s . t . {1}_{i} ( {z}_{i}^{T} {Az}_{i} - b ) \geq 1 - {ξ}_{i} \\ {ξ}_{i} \geq 0 , A ≽ 0 \qquad ( 25 )$$

Since matrix A is a positive semi-definite value matrix, L1 norm of eigenvalues can be minimized by minimizing its trace (sum of eigenvalues). In this way, the eigenvalues can be made sparse (placing at a lower rank). As such, the dual problem of Equation 25 can be expressed by the following Equation 26:

$$[ Equation 26 ]$$

$$max {\sum }_{i = 1}^{m} {α}_{i} \\ s . t . D = I - {\sum }_{i} {1}_{i} {α}_{i} {z}_{i} {z}_{i}^{T} ≽ 0 \\ 0 \leq {α}_{i} \leq {C}_{i} , {\sum }_{i = 1}^{m} {α}_{i} {1}_{i} = 0 \qquad ( 26 )$$

In Equation 26, D is a dual variable of matrix A, and presents a positive semi-definite value. When a positive semi-definite value condition related to this dual variable D is approximated with a linear condition, the resulting condition can be expressed by the following Equation 27:

$$[ Equation 27 ]$$

$${d}^{T} ( I - {\sum }_{i = 1}^{m} {1}_{i} {α}_{i} {z}_{i} {z}_{i}^{T} ) d \geq 0 , ∀ d \qquad ( 27 )$$

With the use of the linear condition shown in Equation 27 (positive semi-definite value condition approximated with a linear condition), the dual problem shown in Equation 26 can be expressed by the following Equation 28:

$$[ Equation 28 ]$$

$$max {\sum }_{i = 1}^{m} {α}_{i} \\ s . t . {d}_{k}^{T} ( I - {\sum }_{i} {1}_{i} {α}_{i} {z}_{i} {z}_{i}^{T} ) {d}_{k} \geq 0 \\ 0 \leq {α}_{i} \leq {C}_{i} , {\sum }_{i = 1}^{m} {α}_{i} {1}_{i} = 0 \qquad ( 28 )$$

Assume herein that the norm of dₖ in Equation 28 is “1.” It is generally known that when there are an infinite number of dk, a dual problem ends up in the same problem as an original positive semi-definite value planning problem. In this case, the dual problem can be treated as a “linear planning problem” for finding the maximum value (or a minimum value) of a linear objective function under a restrictive condition expressed by a linear inequality, and the dual problem is expressed by the following Equation 29:

$$[ Equation 29 ]$$

$$min trace ( {\sum }_{k = 1}^{K} {x}_{k} {d}_{k} {d}_{k}^{T} ) + {\sum }_{i = 1}^{m} {C}_{i} {ξ}_{i} \\ s . t . {1}_{i} ( {z}_{i}^{T} ( {\sum }_{k = 1}^{K} {x}_{k} {d}_{k} {d}_{k}^{T} ) {z}_{i} - b ) \geq 1 - {ξ}_{i} \\ {ξ}_{i} \geq 0 , {x}_{k} \geq 0 \qquad ( 29 )$$

The problem shown in Equation 29 is a linear planning problem, and original solution A for the problem corresponds to the following Equation 30:

$$[ Equation 30 ]$$

$${\sum }_{k = 1}^{K} {x}_{k} {d}_{k} {d}_{k}^{T} \qquad ( 30 )$$

For sequentially solving the problem of Equation 29, the basis for selecting a to be updated is to select α so as to least satisfy the restrictive conditions of the main problem.

Distance d is also a problem for minimizing a value presented by the following Equation 31 (left side of the restrictive condition shown in the aforementioned Equation 28):

$$[ Equation 31 ]$$

$${d}_{k}^{T} ( I - {\sum }_{i} {1}_{i} {α}_{i} {z}_{i} {z}_{i}^{T} ) {d}_{k} \qquad ( 31 )$$

Thus, the above problem ends up in a problem for finding a maximum eigenvector for a value shown in the following Equation 32:

$$[ Equation 32 ]$$

$${\sum }_{i} {1}_{i} {α}_{i} {z}_{i} {z}_{i}^{T} \qquad ( 32 )$$

When metric learning unit 330 is caused to execute the foregoing method, its algorithm is defined in the following manner.

(1) an initial value of α is selected, and the dual problem shown in Equation 28 is solved to determine distance d; and

(2) The linear planning problem of Equation 29 corresponding to the dual problem shown in Equation 28 is solved using distance d to again select α.

Termination conditions applied when this problem is solved dictates that a minimum eigenvalue for a value expressed by the following Equation 33 is non-negative, and that the restrictive conditions included in the linear planning problem of Equation 29 are all satisfied.

$$[ Equation 33 ]$$

$$I - {\sum }_{i} {1}_{i} {α}_{i} {z}_{i} {z}_{i}^{T} \qquad ( 33 )$$

By sequentially solving the linear planning problem, it is possible to reduce the processing time for finding a solution for the aforementioned dual problem and to efficiently solve the dual problem. In this regard, the solution applied in this explanatory example is a combination of an approach called “cutting plane” and an approach called “column generation.”

Metric learning unit 330 outputs the values of matrix A, group center cₖ, group radius Rₖ, and slack variable ξ, and the like which have been found in accordance with the aforementioned approaches. Metric learning result storage unit 350 stores the respective values output by metric learning unit 330. When the user repeatedly uses active metric learning device 100 a plurality of times, metric learning result storage unit 350 also stores “use history information” in which use histories are registered.

Next, a description will be given of a “metric visualization processing” operation performed by metric visualization unit 340 to display an optimized metric result on a display device connected to input/output interface 50 for allowing the user to view the metric result optimized by metric optimization unit 300.

Metric visualization unit 340 displays metric parameters (matrix A) on the display device connected to input/output interface 50 shown in FIG. 1. Here, matrix A includes diagonal components which present information indicative of the importance of attributes, and non-diagonal components which present information indicative of similarities between the attributes. Thus, each item of information contained in matrix A is displayed on the display device as metric map diagram MM for visualization.

“Metric map diagram MM” is a diagram that shows matrix A by mapping matrix A to a lower dimensional space, and permits the user to visually recognize the importance of attributes possessed by data under analysis D1 to Dn, and the relevance between the attributes. By allowing the user to directly edit this metric map diagram MM, feedback information FD can be entered into feedback information capture unit 500.

In the following, a description will be given of “metric map diagram MM” which is displayed by metric visualization unit 340 in order to visualize an optimized metric.

As shown in FIG. 11, metric map diagram MM extends edges between attributes which present high similarities to provide a graphical representation using non-diagonal components of the metric parameters (matrix A).

Further, metric visualization unit 340 calculates the coordinates of each attribute in a lower dimensional space (two-dimensional space in FIG. 11) and draws the attributes through multi-dimensional scaling. In metric map diagram MM shown in FIG. 11, characters indicative of the names of attributes (words) are displayed in larger sizes as larger weights are given to the attributes, in order to reflect the “weights of the attributes” to metric map diagram MM.

Since matrix A is a “similarity matrix” indicative of the degree of similarity, it can be applied to the analysis of kernel main components and the like as well. In this way, by analyzing elements contained in matrix A using metric map diagram MM, the user can obtain findings related to the learned metric.

If the learned result does not fit to an object desired by the user, new restrictive conditions may be set (given), the set restrictive conditions may be applied, and a new learning operation may be executed. For this purpose, feedback information capture unit 500 (user interface) can be provided for allowing the user to set new restrictive conditions for metric map diagram MM, thus readily adding restrictive conditions.

Metric learning device 100 of the present invention may be configured to execute a variety of metric learning operations in accordance with data under analysis D1 to Dn entered from the outside, when it performs the metric learning operation under the aforementioned restrictive conditions.

To this end, metric learning device 100 comprises active learning processing unit 410 which provides a plurality of different operation modes for metric learning in accordance with entered data.

In the following, a description will be given of each operation mode provided by active learning processing unit 410.

A first operation mode is a “first metric learning mode” which entails metric learning that employs data under analysis D1 to Dn or the result of processing derived through application of the metric to data under analysis D1 to Dn. In the first metric learning mode, (a) active learning processing unit 410 first extracts important data IM critical to an analysis. Important data IM extracted herein depends on a problem subjected to the processing operation and data under analysis D1 to Dn. A problem subjected to the processing operation may be exemplified by a general technical experiment planning method, extraction of points corresponding to a hub on a network from the relevance (including correlation) between data, and the like. Subsequently, (b) active learning processing unit 410 extracts important attributes from among attributes possessed by extracted important data IM. Important attributes may be extracted by a general extraction method.

A second operation mode is a “second metric learning mode” which entails the metric learning that employs the result of processing derived through application of the metric to data analysis result AR and data under analysis D1 to Dn. In the second metric learning mode, active learning processing unit 410 extracts important data IM for data analysis result AR. Extracted important data IM depends on a problem subjected to the processing operation and data under analysis D1 to Dn. For example, points that are close to a classification plane (margin index) and the like can be used for the classification problem shown in FIG. 7a and the clustering shown in FIG. 8a.

In a “third metric learning mode”, active learning processing unit 410 actively performs the metric learning operation by predicting feedback information FD which will be next captured by feedback information capture unit 500, from the metric parameters and use history information stored by metric storage unit 350, changes of the metric from data under analysis D1 to Dn, and the relevance such as correlations among respective attributes possessed by respective data under analysis D1 to Dn. Predicted feedback information FD as described herein includes, for example, new attributes, relevance of the new attributes, attributes which become unnecessary, relevance which becomes unnecessary, and the like. Such active learning operations performed in accordance with changes in feedback information FD are operations characteristic of the present invention, and are not demonstrated by general metric learning techniques.

A “fourth metric learning mode” involves execution of “feedback conversion processing” by feedback conversion unit 310 using feedback information FD to generate side-information SD which indicates interpretations of feedback information FD. For example, when feedback information FD is entered indicating that a cluster is not required, a message is displayed for prompting the user to ascertain whether or not documents included in the cluster are necessary, whether or not the importance assigned to some attributes is excessively high, and the like. Then, active learning processing unit 410 actively executes the metric learning operation in accordance with instructions entered by the user (for example, the documents are necessary, the importance is excessively high, and the like) in response to the message.

Alternatively, in the “fourth metric learning mode,” information likely to be relevant to some attribute may be identified and automatically extracted from among feedback information FD, and a message may be displayed to prompt the user for confirmation. When the user, in response to the message, enters feedback information FD that “two classes are identified with each other (treated as the same class for purposes of processing), by way of example, active learning processing unit 410 displays attributes for treating the two classes as the same class.

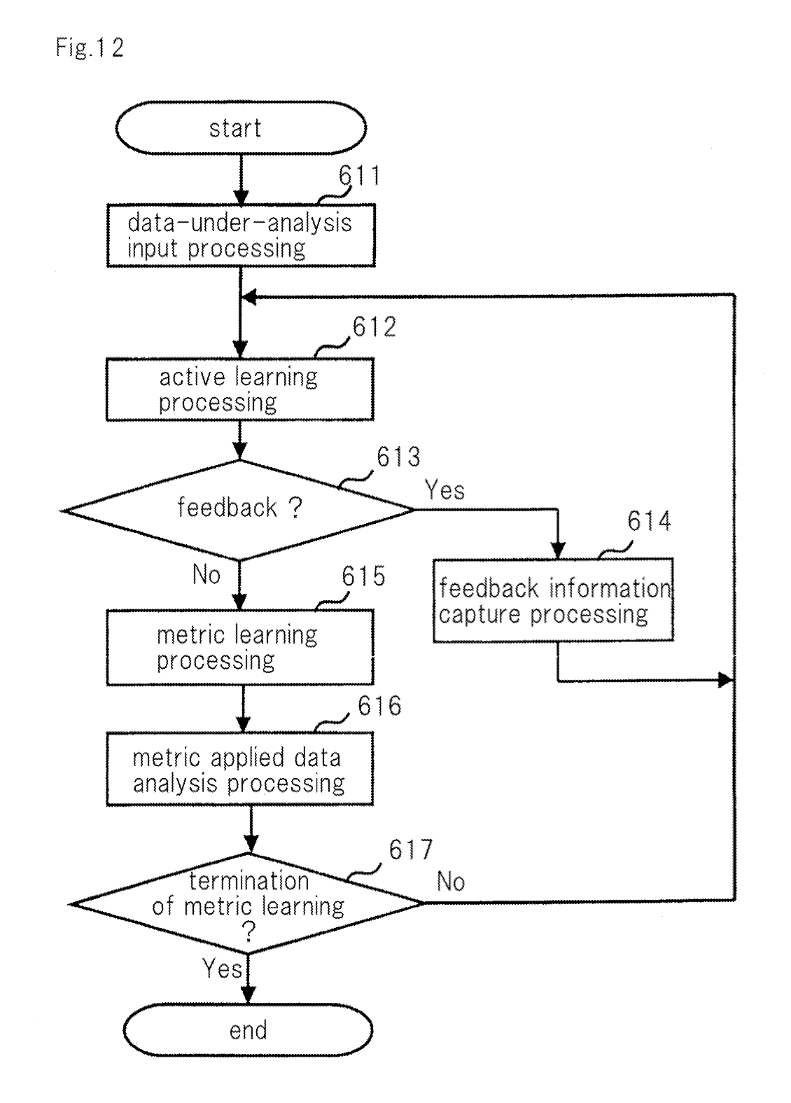

Next, a description will be given of details of metric learning operations performed in metric learning device 100 which has the above-described configuration. As shown in FIG. 12, this series of metric learning operations is executed through “data-under-analysis input processing (step 611)”, “active learning processing (step 612)”, “feedback presence/absence determination processing (step 613)”, “feedback information capture processing (step 614)”, “metric learning processing (step 615)”, “metric applied data analysis processing (step 616)”, and “metric learning termination determination processing (step 617).”

“Data-under-analysis input processing (step 611)” allows metric applied data analysis unit 200, metric optimization unit 300, and active learning unit 400 to capture data under analysis D1 to Dn entered from the outside.

Subsequently, active learning unit 400 determines whether or not the active learning should be performed through a “active learning enable/disable determination processing” operation. When it has determined that the active learning should be performed, active learning unit 400 executes the “active learning processing (step 612)” operation to extract important data IM, determine rankings of extracted important data IM, and the like. When it has determined that the active learning should not be performed, active learning unit 400 executes the processing at step 613, later described, without executing the “active learning processing (step 612)” operation.

Feedback information capture unit 500 executes the “feedback absence/presence determination processing (step 613)” operation to determine whether or not the user has entered feedback information FD. When it has determined that the user has entered feedback information FD (Yes at step 613), feedback information capture unit 500 executes the “feedback information capture processing (step 614)” operation to capture feedback information FD. Subsequently, active learning unit 400 executes the “active learning processing (step 612)” based on feedback information FD captured by feedback information capture unit 500. On the other hand, when feedback information capture unit 500 has determined that feedback information FD has not been entered (No at step 613), active learning unit 400 executes the processing at step 615, later described.

Metric optimization unit 300 executes the “metric learning processing (step 615)” operation to convert feedback information FD captured by feedback information capture unit 500 into side-information SD. Then, metric optimization unit 300 executes an optimization processing operation for the metric so as to satisfy conditions indicated by converted side-information SD, and outputs the values of matrix A, group radius Rₖ, group center cₖ, slack function ξ and the like, derived through the optimization processing operation.

Metric applied data analysis unit 200 executes the “metric applied data analysis processing (step 616)” operation to apply the metric using matrix A optimized by metric optimization unit 300 to data under analysis D1 to Dn. Then, metric applied data analysis unit 200 calculates the values of data under analysis D1 to Dn after the metric has been applied thereto, and analyzes the calculated value. Next, metric applied data analysis unit 200 outputs data analysis result AR to the display device connected to input/output interface 50.

Metric optimization unit 300 executes the “metric learning termination determination processing (step 617)” operation to determine whether or not active metric learning device 100 has been instructed to terminate the metric learning. When not instructed to terminate metric learning (No at step 617), active learning unit 400 again executes processing at step 612. On the other hand, when instructed to terminate metric learning (Yes at step 617), active metric learning device 100 terminates the sequence of metric learning operations.

Next, a description will be given of a specific example where active metric learning device 100 learns metrics related to a variety of problems in accordance with such metric learning operations.

A problem intended by active metric learning device 100 for processing may be a problem in an arbitrary scenario. As a first example, active metric learning device 100 can be applied when a marketer of commodity products classifies blog data or sentence data, collected for a predetermined period as one unit, from among blog data related to commodity products according to their content (topics), and extracts or collects trends and reputations from the classified data.

As a second example, active metric learning device 100 can also be applied when a researcher, who is to start research newly assigned thereto, searches information in a field to which the research belongs.

In either of the foregoing examples, if a general clustering system is employed, preprocessing is first required to select a set of words used in the analysis. This selection task requires special knowledge, and is labor intensive. However, in active metric learning device 100 of the present invention, active learning unit 400 identifies information likely to provide feedback (for example, hints), important attributes, and the like, and outputs them (for example, displays them on the display device, or the like). Therefore, the user can acquire additional information on vocabulary, and the like, when the user selects words, and can make a search for information and the like even if the user does not have expert knowledge.

Also, metric optimization unit 300 optimizes the importance and relevance degree related to words, such that they satisfy conditions indicated by side-information SD when attributes and document clustering are concerned. Specifically, with a general clustering system, when the user selects a set of words intended for a search as preprocessing, the user is likely to fail to select preferred works unless the user has expert knowledge. In contrast, metric learning device 100 of the present invention provides an auxiliary function when the user selects a set of words because the metric is optimized.

Further, metric learning device 100 can also process problems related to failure diagnosis for mechanical systems and the like. In this case, metric learning device 100 can efficiently detect attributes which can cause failures, and the relevance between the attributes through an outlier detection problem for detecting outlier which deviate from a predetermined reference value, a classification problem, clustering and the like.

In the following, a detailed description will be given of an example concerning “document clustering” which is the first example described above. Assume in this example that entered data under analysis is “document data.” Through “evaluation processing” executed before metric learning, document data is evaluated such that a metric can be defined therefor, and is represented in the form of a vector. While no particular limitations are imposed on an evaluation method, methods applicable to this example include, for example, a method of extracting words making use of a known morpheme analysis or the like, a method of defining and extracting attributes of a document, and the like.

The metric subjected to learning in the “document clustering” is “distance d(xᵢ, xⱼ) between respective documents” which is expressed by aforementioned Equation 2 using metric parameter A. Parameters (matrix A) for calculating the metric are formatted in a matrix which represents the importance of word and the relevance degree between words.

Entered data under analysis is evaluated through “evaluation processing,” and then stored in data-under-analysis storage unit 110 as a document vector.

Active learning device 400 scores the data under analysis (document data) in accordance with the importance degree of the data by a general experiment planning method, or a general singular value detection method such as one-class SVM.

With respect to attributes as well, active learning device 400 calculates the importance degree by a method similar to the above, and displays the content of questions on data and important attributes (including questions for confirming whether an attribute is important or outlier, confirming whether data is important or outlier, and the like) using the calculated important degree, and a message for prompting the user to answer the respective questions on the display device (not shown) connected to input interface 50. Active learning result storage unit 440 stores feedback information FD indicative of answers to the questions entered by the user in response to the message displayed on the display device (not shown).

Active metric learning device 100 deletes the importance degree related to data under analysis and attributes, used attributes, and used data based on the contents of the answers returned from the user, indicated by feedback information FD stored in active learning result storage unit 440. Data-under-analysis storage unit 110 stores the result of the deletion.

Metric optimization unit 300 can also be used to perform a metric learning operation using the result of active learning. In this case, metric optimization unit 300 learns metric parameters such that a weight for an important word (or document) is increased while a weight for a trivial word (or document) is decreased. The metric parameters learned in metric optimization unit 300 are stored in metric learning result storage unit 350.

Subsequently, data analysis unit 220 performs a cluster analysis using the reduced data or the result of the metric learning. The cluster analysis is performed in the same manner as a general cluster analysis method. The active learning processing operation may be omitted in the cluster analysis. In this case, the cluster analysis may be executed using inter-data distance d(xᵢ, xⱼ) as basic information for entered data. Analysis result storage unit 250 stores data analysis result AR derived through the cluster analysis.

The foregoing processing will be described using a more detailed specific example. First, active metric learning device 100 captures blog articles about PC (Personal Computer) entered by the user through a keyboard or the like connected to input/output interface 50.

Next, CPU 10 extracts words from the contents of the captured blog articles using a general morpheme analysis program (for example, Juman), classifies the extracted words, and transforms one article to one vector (document vector). Data-under-analysis storage unit 110 stores each article transformed into a vector.

Data analysis unit 220 executes a main component analysis on each vector transformed article and attributes to extract data (articles) and attributes located near the center of a distribution as well as data and attributes outside of the distribution. A method for the main component analysis made herein may be a general main component analysis method.

Active metric learning device 100 displays the contents of questions on the importance of words and attributes (whether a certain word presents an important value or an outlier, whether a certain attribute presents an important value or an outlier, and the like) and a message for prompting the user to answer the questions on a display unit (not shown). Active learning result storage unit 440 stores feedback information FD (answers to the questions entered by the user) captured by feedback information capture unit 500. The answer of the user may be, for example, “Yes” for an important value, and “No” for an outlier.

Assume that in this example, a first question is displayed as follows.

### (First Exemplary Question)

Do “Year 2007,” “diary,” “PC,” and “mobile PC,” which frequently appear in blog data respectively present important values or outliers?

Also, assume that feedback information capture unit 500 has received the following answer from the user, as the answer to the first question:

### (Exemplary Answer to First Question) NO, NO, YES, YES

Assume that in this example, a second question is further displayed as follows.

### (Second Exemplary Question)

Do “ACER” and “haiku,” which are estimated to present outliers, respectively present an important value or an outlier?.

### (Exemplary Answer to Second Question) YES, NO

Active learning result storage unit 440 stores therein feedback information indicative of the answer of the user to each question, received by feedback information capture unit 500.

Also, two different operations (actions) can be available for feedback information FD received from the user through feedback information capture unit 500.

A “first action” involves the fact that CPU 10 “deletes” data which is not important or attributes which are not important. In this case, the remaining data under analysis, after the deletion of the data which are not important, are stored in data-under-analysis storage unit 110.

Subsequently, metric optimization unit 300 optimizes the metric parameters (matrix A), using the answer of the user as feedback information FD, such that matrix A reflects the answer of the user. Metric storage unit 350 stores the result produced through the optimization.

Data analysis unit 220 executes a general k-means cluster analysis using metric parameter A optimized by metric optimization unit 300. Analysis result storage unit 250 stores the result produced through the k-means cluster analysis.

When no previous information is available, the metric parameters for use in the initial (first) analysis may be a unit matrix which presents the same weight and the similarity set at “0” to all attributes. On the other hand, when some previous information is available or when the user wishes to start an analysis following the result of a previous analysis, an arbitrary matrix may be used as an initial matrix for the metric. The metric parameters (matrix A) has been stored in metric learning result storage unit 350.

The result of the cluster analysis stored in analysis result storage unit 250 includes information indicative of a cluster to which each document belongs. Based on the result of the cluster analysis, it is possible to identify all document vectors which belong to each cluster. In this way, the cluster center, cluster radius (for example, an average, a 75-% point of the distance from the center of the cluster), and the like can be calculated. Analysis result output unit 230 calculates the cluster center and cluster radius, and analysis result storage unit 250 stores the result of the calculation.

By referring to analysis result map diagram AM (cluster map diagram) for illustrating the result of the analysis made by data analysis unit 220, the user can overlook the result of the analysis made by data analysis unit 220. The user can also browse details. This cluster map diagram comprises the following three elements.

1. The size of each cluster (the number of data which belong to the cluster), cluster radius;

2. the number of feature attributes (feature words) which characterize each cluster, the number of documents which include the feature words, and simple statistic amounts such as the proportion in which the feature words appear in the cluster; and

3. a placement which reflects the distance between clusters, and a link for indicating the similarity of clusters.

Now, a description will be given of a cluster map diagram which is an example of analysis result map diagram AM.

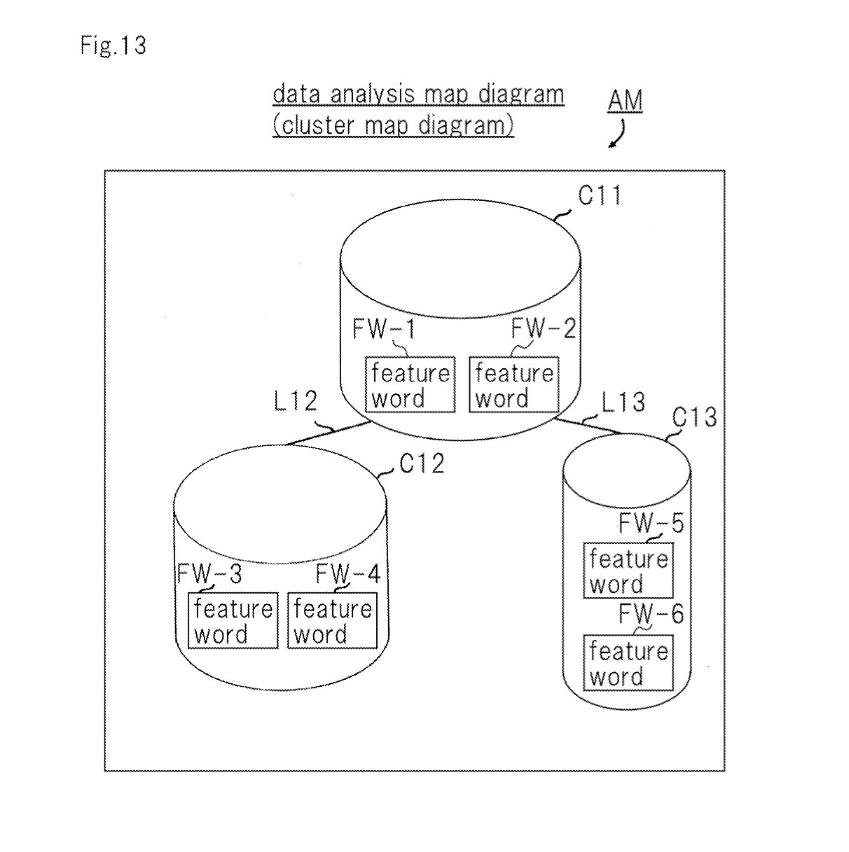

As shown in FIG. 13, in analysis result map diagram AM (cluster map diagram), each cluster C11, C 12, C13 is represented by a cylinder. The volume of Each cylinder represents the number of documents included in each cluster C11 to C13, and the radius of the cylinder represents the extent to which a distribution scatters (dispersion). Also, the example of FIG. 13 presents a plurality of feature words FW1-FW6 in each cluster. Also, a “link” is extended between clusters which are similar to each other for indicating that they are similar to each other. For example, link L12 is extended to indicate that cluster C11 is similar to cluster C12.

The user can obtain hints and the like from the result of the active learning operation when referencing to this cluster map diagram. Then, the user enters feedback information FD into feedback information capture unit 500 through operations on a keyboard, a mouse or the like connected to the input/output interface shown in FIG. 1.

The following types of information, for example, may be contemplated for feedback information FD which can be entered while the user references analysis result map diagram AM (cluster map diagram) shown in FIG. 13.

1. whether or not a cluster is necessary (either “necessary” or “not necessary”);

2. whether a cluster is “divided” or “coupled” to another cluster; and

3. “connection” or “disconnection” of a link between similar clusters.

These types of feedback information FD are converted into side-information SD by feedback conversion unit 310 after they are received by feedback information capture unit 500.

1. Regarding a necessary cluster, metric learning device 100 extracts document vectors which belong to this cluster and include feature words, and produces a restrictive condition which makes smaller group radius Rₖ of a data set composed of data provided through the extraction. This restrictive condition corresponds to the aforementioned Equation 12c.

2. Regarding an unnecessary cluster, on the other hand, metric learning device 100 decreases the weights of feature words in the cluster. This corresponds to the restrictive condition shown in Equation 12g.

3. When a cluster is divided, metric learning device 100 classifies a plurality of feature words, belonging to the cluster subjected to the division, into a plurality of groups. Subsequently, metric learning device 100 extracts document vectors which include each feature word to create a plurality of clusters (groups). In this case, metric learning device 100 creates a plurality of restrictive conditions shown in Equation 12c.

Further, when divided clusters (groups) are closely spaced by distance d, a feature word which has been included in a cluster before the division can again belong to the same cluster. To avoid this situation, the restrictive condition shown in Equation 12f is used in order to space divided clusters far apart from each other.

4. When a cluster is coupled to another, a group is produced by extracting respective document vectors including feature words of a cluster subjected to the coupling, and merging them. In this case, the restrictive condition shown in Equation 12c is used.

5. For information indicative of the relevance between clusters, the restrictive condition shown in Equation 12e is used when there is short distance d between the clusters. On the other hand, when there is long distance d between the clusters, the restrictive condition shown in Equation 12f is used.

The foregoing restrictive conditions (side-information SD) are stored in side-information storage unit 320.

A description will be next given of an example where feedback information FD is entered by the user.

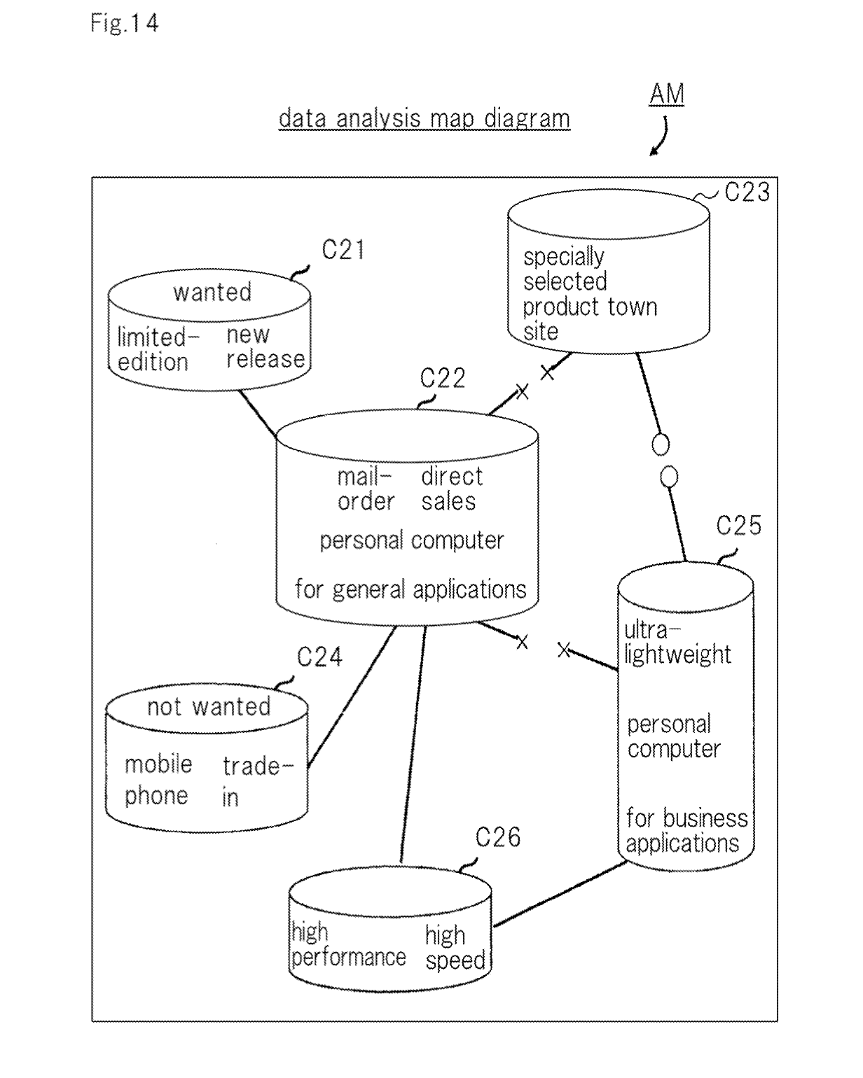

As shown in FIG. 14, when link L is added for connecting between clusters therethrough, a mark (◯ in the figure) indicates that the leading end of a link extending from each cluster can be connected.

In the example of FIG. 14, the user has recognized that personal computers for business applications (feature words belonging to cluster C25) are commercially available on a site named “specially selected product town” (feature words belonging to cluster C23). Thus, the user attempts to connect cluster C25 and cluster C23 to each other.

On the other hand, for disconnecting link L between clusters, a mark (X in the figure) indicates that a leading end of a link extending from each cluster is not connected.

In the example of FIG. 14, the user wishes a personal computer for business applications (feature words belonging to cluster C25), and has recognized that direct sales sites exclusively offer personal computers for general applications (feature words belonging to cluster C22). Accordingly, the user attempts to disconnect cluster C25 from cluster C22.

The user has further recognized that the site named “specially selected product town” (feature words belonging to cluster C23) does not sell personal computers for general applications (feature words belonging to cluster C22). Accordingly, the user attempts to disconnect cluster C23 from cluster C22.

Also, in the example of analysis result map diagram AM shown in FIG. 14, the user has recognized that feature words in cluster C21 are necessary, but has also recognized that feature words in cluster C24 are not necessary (outlier). Accordingly, feedback information FD is entered into feedback information capture unit 500 in correspondence to the recognition of the user.

Subsequently, feedback conversion unit 310 converts feedback information FD to generate side-information SD. Side-information storage unit 320 stores generated side-information SD. Metric learning unit 330 optimizes metric parameters A using this side-information SD. Metric learning result storage unit 350 stores the resulting metric parameters (matrix A). Metric visualization unit 340 displays metric map diagram MM representative of learned matrix A on the display device (not shown).

As previously shown in FIG. 11, each word is displayed within a rectangular frame in “metric map diagram MM.” Also, the size of each rectangle represents the importance degree of the word. Further, the similarity between words is represented by the length or width of a link between the words. As described above, the importance degrees of words constitute diagonal components of metric parameters (matrix A), while the inter-word similarities constitute non-diagonal components of matrix A.

The user can enter feedback information FD related to the importance degrees of words and inter-word similarities into feedback information capture unit 500 with reference to this metric map diagram MM. Further, the user can additionally register a word, and enter similarities between the registered word and other words.

Active learning unit 400 also performs adjustments, optimization and the like of the feedback procedure, in addition to questions related to important data and attributes.

Specifically, metric learning unit 400 displays an optimized order for selecting a variety of feedback information FD such that the user can get hints for achieving a desired object. The “order for selecting feedback information FD,” referred to herein, means a sequence of selection order such as first selecting unnecessary clusters, next selecting necessary clusters, and further selecting feedback related to inter-cluster links. Active learning result output unit 430 displays a message for prompting the user to make selections in accordance with this selection order. In doing so, the analysis time can be reduced by the number of times of analysis loops from the start to the end of the metric learning processing.

Metric applied data analysis unit 200 uses the resulting metric to analyze metric applied data. In this way, metric applied data analysis unit 200 ascertains whether or not the metric result found based on feedback information FD fits to a data analysis result desired by the user.

Metric learning processing unit 330 applies the metric corresponding to feedback information FD which has been entered while analysis result map diagram AM is displayed. Metric visualization unit 340 displays the result of the clustering after application of the metric (metric map diagram MM).

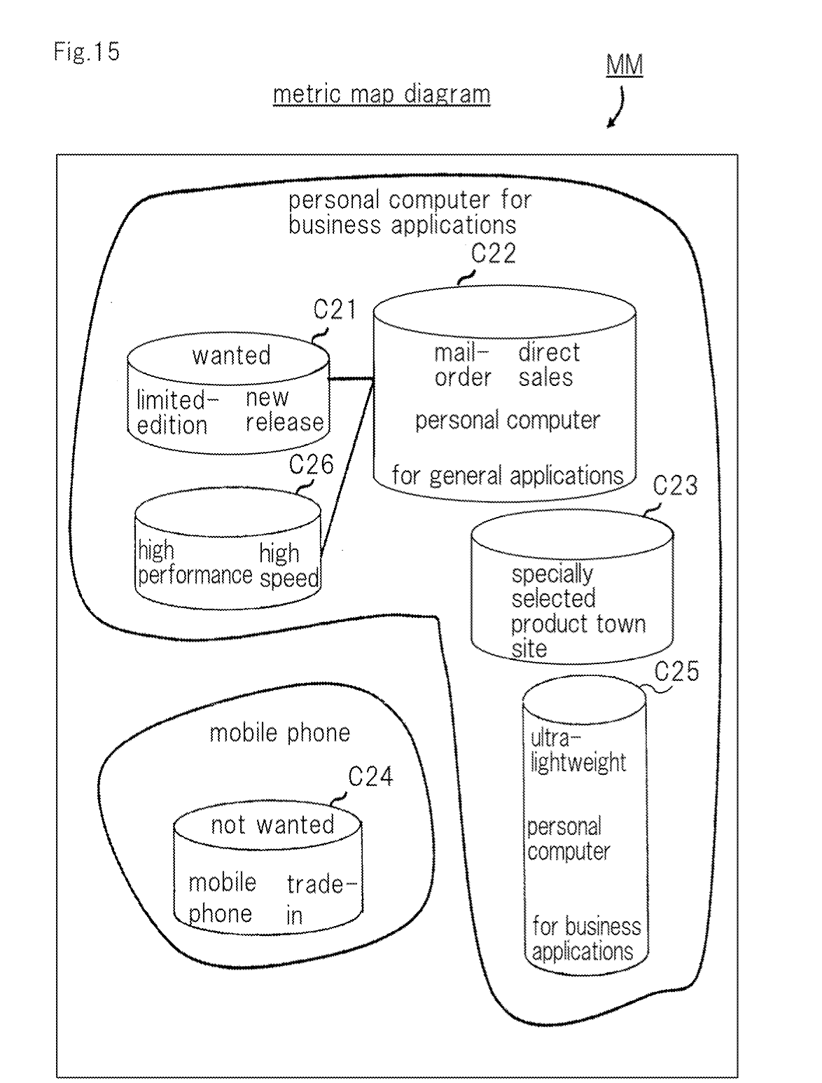

For example, when the metric is applied corresponding to feedback information FD which has been entered while analysis result map diagram AM shown in FIG. 14 is displayed, a clustering result (metric map diagram MM) is produced as shown in FIG. 15. In this example, metric map diagram MM is divided into sets of personal computer and mobile telephone.

Further, clusters are classified by applications into those related to personal computers for business applications, and clusters related to sales of personal computers for general applications. The user can enter new feedback information FD and instruct the metric learning device 100 to again execute the active metric learning in order to further modify the metric result of FIG. 15 such that the metric result better fits to a desired purpose.

When the user can reach the desired purpose, metric optimization unit 300 executes the “metric learning termination determination processing” operation to determine whether or not the user has instructed it to terminate the metric learning operation. When determining that the user has instructed the termination of metric learning, metric optimization unit 300 terminates the metric learning operations.

As described above, according to active metric learning device 100 of the present invention, feedback conversion unit 310 generates side-information SD required for the metric learning operation based on feedback information FD captured from the outside, and metric learning unit 330 executes the metric learning operation based on side-information SD.

In this way, active metric learning device 100 of the present invention can process more diverse side-information SD than general metric learning devices, and can sufficiently utilize information possessed by the user.

Further, according to active metric learning device 100 of the present invention, metric visualization unit 340 generates metric map diagram MM which represents metric parameters (for example, matrix A or the like) that are mapped to a lower dimensional space. This allows the user to recognize the metric parameters (for example, matrix A) learned by metric optimization unit 300 of metric learning device 100 by referencing to this metric map diagram MM.

Furthermore, according to active metric learning device 100 of the present invention, metric optimization unit 300 is provided with a user interface for allowing the user to add new restrictive conditions to metric parameters shown by metric map diagram MM. This user interface contributes to alleviate efforts of the user to generate side-information SD (for example, efforts in processing for querying data).

Moreover, according to active metric learning device 100 of the present invention, active learning unit 400 extracts, from among data analysis result AR and data under analysis DI to Dn, important data IM that is likely to affect data analysis result AR. Then, active learning unit 400 ranks extracted important data IM, and active learning result output unit 430 outputs the result of active learning. This allows important information extracted from a large amount of data under analysis D1 to Dn to be presented to the user, thus improving efficiency of the user's work.

Yet furthermore, according to active metric learning device 100 of the present invention, a plurality of groups are generated, each including at least one data item under analysis among data under analysis D1 to Dn captured from the outside, and the metric is optimized based on group center cₖ and group radius Rₖ defined by each group.

In this way, the processing cost when learning the metric in data analysis can be reduced.

In the present invention, the processing in active metric learning device 100 may be such that a program for implementing its functions is recorded on a recording medium which is readable in active metric learning device 100, and the program recorded on the recording medium is read into and executed by active metric learning device 100, other than that implemented by the aforementioned dedicated hardware. The recording medium readable in active metric learning device 100 refers to HDD built in active metric learning device 100 and the like in addition to portable recording media such as floppy disk (registered trademark), magneto-optical disk, DVD, CD and the like. This program recorded on the recording medium is, for example, read by CPU 10 contained in active metric learning device 100, so that processing similar to the aforementioned is performed under the control of CPU 10.

CPU 10 contained in active metric learning device 100 acts as a computer for executing a program read from a recording medium which has recorded thereon the program.

While the present invention has been described above with reference to some embodiments, the present invention is not limited to the embodiments described above. The present invention can be modified in configuration and details in various manners which can be understood by those skilled in the art without departing from the spirit and scope of the present invention.

This application claims the priority under Japanese Patent Application No. 2008-041420 filed Feb. 22, 2008, the disclosure of which is incorporated herein by reference in its entirety.

1. An active metric learning device comprising:
a metric applied data analysis unit including:
a metric application unit that receives data under analysis having a plurality of attributes and a metric for calculating the distance between the data under analysis, and that calculates the distance between the data under analysis;
a data analysis unit that analyzes the data under analysis with a predetermined function using the distance between the data under analysis calculated by said metric application unit, and that outputs a data analysis result generated through the analysis; and
an analysis result storage unit that stores the data analysis result generated by said data analysis unit; and
a metric optimization unit including:
a feedback conversion unit that generates side-information which presents information required for metric learning, based on instructions indicated by feedback information entered from the outside, said feedback information including similarities between the data under analysis stored in said analysis result storage unit or the attributes or a combination thereof; and
a metric learning unit that generates a metric that complies with a predetermined condition based on the side-information generated by said feedback conversion unit, and that stores the generated metric in a metric learning result storage unit,
wherein said metric application unit calculates the distance between the data under analysis using the metric stored in said metric learning result storage unit.

2. The active metric learning device according to claim 1, further comprising an active learning unit that actively learns the data under analysis based on either the data under analysis, or data derived by applying the metric to the data under analysis, or an analysis result which is the result of analyzing the metric, or a combination thereof, and that stores the result of the active learning in an active learning storage unit.

3. The active metric learning device according to claim 1, wherein:
said metric applied data analysis unit comprises:
a dimension conversion unit that applies a dimensional conversion to the analysis result stored in said analysis result storage unit; and
an analysis result output unit that displays the analysis result after said dimension conversion unit has applied the dimensional conversion thereto.

4. (canceled)

5. The active metric learning device according to claim 1, wherein said side-information generated by said feedback conversion unit includes information indicative of a similarity between sets of the data under analysis, the distance between the data-under-analysis set and the data under analysis, and pair information indicative of the relationship between the data under analysis and another data under analysis.

6. The active metric learning device according to claim 1, wherein said active learning unit comprises:
an active learning processing unit that identifies an attribute correlated to an attribute which has been fed back in the past, based on the data under analysis, or data generated by applying the metric to the data under analysis, or the analysis result, or a combination thereof; and
an active learning result output unit that presents an attribute identified by said active learning processing unit as a candidate for feedback.

7. The active metric learning device according to claim 1, wherein said metric application unit calculates the distance between the data under analysis based on a product of a metric parameter subjected to the metric, and the difference between data under analysis subjected to the calculation of the distance.

8. The active metric learning device according to claim 1, wherein said data analysis unit analyzes the data under analysis using the predetermined function which is a linear conversion of the data under analysis.

9. The active metric learning device according to claim 2, wherein an experiment planning method is used, or a margin is maximized, or a mutual information amount is optimized when the predetermined important data is learned.

10-11. (canceled)

12. The active metric learning device according to claim 1, wherein
said feedback conversion unit uses the feedback information which indicates at least one from among: whether or not a cluster is necessary, whether or not an attribute is necessary, and an adjustment to an inter-cluster distance, when said feedback conversion unit generates the side-information; and
said feedback conversion unit performs at least one from the followings:
when said feedback information indicates that a cluster is necessary, said feedback conversion unit generates the side-information to meet a restrictive condition which dictates that the distance between data having a characteristic attribute of the cluster is reduced;
when said feedback information indicates that a cluster is necessary, said feedback conversion unit generates the side-information to meet a restrictive condition which dictates that the importance degree is increased for a characteristic attribute of the cluster;
when said feedback information indicates that a cluster is not necessary, said feedback conversion unit generates the side-information to meet a restrictive condition which dictates that the importance degree is reduced for a characteristic attribute of the cluster;
when said feedback information indicates that the distance between clusters is adjusted, said feedback conversion unit generates said side-information to meet a restrictive condition which dictates that the distance between the centers of the clusters is adjusted;
when said feedback information indicates that a cluster is divided, said feedback conversion unit generates side-information to identify a plurality of characteristic attributes within the cluster, extract data which includes the attributes, and increase the importance degree for each of the data;
when said feedback information indicates that a cluster is divided, said feedback conversion unit generates side-information to identify a plurality of characteristic attributes within the cluster, extract data which includes the attributes, increase the importance degree for each of the data, and bring the centers of respective sets further away from each other;
when said feedback information indicates that a cluster is divided, said feedback conversion unit generates side-information to again cluster the cluster, and to separate data within a plurality of clusters resulting from the clustering from the center thereof by a smaller distance; and
when said feedback information indicates that a cluster is divided, said feedback conversion unit generates side-information to again cluster the cluster, separates data within a plurality of clusters resulting from the clustering from the center thereof by a smaller distance, and space the centers apart from each other by a larger distance.

13-20. (canceled)

21. The active metric learning device according to claim 3, wherein said dimension conversion unit performs the dimension conversion with the use of one of the followings: a singular value resolution; a singular value resolution which imposes a constraint to bring the analysis result closer to a conversion result generated by a dimension conversion which has been executed immediately before the dimension conversion; a non-negative matrix resolution; a non-negative matrix resolution which imposes a constraint to bring the analysis result closer to a conversion result generated by a dimension conversion which has been executed immediately before the dimension conversion.

22-24. (canceled)

25. The active metric learning device according to claim 1, wherein for generating the metric, said metric learning unit solves one of the following: a positive semi-definite value planning problem using a general library; a positive semi-definite value planning problem transformed on the basis of labels given to groups that comprise the data under analysis by dividing the positive semi-definite value planning problem into small problems each including a single variable case, and repeatedly executes optimization; and a positive semi-definite value planning problem with lower ranks given to metric parameters subjected to the metric by dividing the positive semi-definite value planning problem into small problems each including a single variable case, and repeatedly executes optimization.

26-27. (canceled)

28. The active metric learning device according to claim 6, wherein said active learning processing unit identifies the correlated attribute based on one of the followings: a correlation coefficient; a collocation score; a mutual information amount; and a conditional probability.

29-31. (canceled)

32. An active metric learning method comprising:
metric applied data analysis processing including:
metric application processing that receives data under analysis having a plurality of attributes and a metric for calculating the distance between the data under analysis, and that calculates the distance between the data under analysis;
data analysis processing that analyzes the data under analysis with a predetermined function using the distance between the data under analysis calculated by said metric application processing, and that outputs a data analysis result generated through the analysis; and
analysis result storage processing that stores the data analysis result generated by said data analysis processing operation; and
metric optimization processing including:
feedback conversion processing that generates side-information which presents information required for metric learning, based on in instructions indicated by feedback information entered from the outside, said feedback information including similarities between the data under analysis stored through said analysis result storage processing or the attributes or a combination thereof; and
metric learning processing that generates a metric that complies with a predetermined condition based on the side-information generated by said feedback conversion processing, and that stores the generated metric through a metric learning result storage processing operation,
wherein said metric application processing calculates the distance between the data under analysis using the metric stored through said metric learning result storage processing operation.

33. The active metric learning method according to claim 32, further comprising active learning processing that actively learns the data under analysis based on the data under analysis, or data derived by applying the metric to the data under analysis, or an analysis result which is the result of analyzing the metric, or a combination thereof, and that stores the result of the active learning in active learning storage processing.

34. The active metric learning method according to claim 32 wherein
said metric applied data analysis processing comprises:
dimension conversion processing that applies a dimensional conversion to the analysis result stored in said analysis result storage processing; and
analysis result output processing that displays the analysis result after the dimensional conversion has been applied thereto in said dimension conversion processing.

35. (canceled)

36. The active metric learning method according to claim 32, wherein said side-information generated in said feedback conversion processing includes information indicative of a similarity between sets of the data under analysis, the distance between the data-under-analysis set and the data under analysis, and pair information indicative of the relationship between the data under analysis and other data under analysis.

37. The active metric learning method according to claim 33, by further comprising:
active learning processing that identifies an attribute correlated to an attribute which has been fed back in the past, based on either the data under analysis, or data generated by applying the metric to the data under analysis, or the analysis result, or a combination thereof; and
active learning result output processing that presents an attribute identified by said active learning processing as a candidate for feedback.

38. The active metric learning method according to claim 32, wherein said metric application processing includes calculating the distance between the data under analysis based on the product of a metric parameter subjected to the metric, and the difference between data under analysis subjected to the calculation of the distance.

39. The active metric learning method according to claim 32, wherein said predetermined function used to analyze the data under analysis in said data analysis processing is a linear conversion of the data under analysis.

40. The active metric learning method according to claim 33, wherein an experiment planning is used, or a margin is maximized, or a mutual information amount is optimized when the predetermined important data is learned.

41-42. (canceled)

43. The active metric learning method according to claim 32, wherein said feedback conversion processing includes generating the side-information using the feedback information which indicates at least one from among: whether or not a cluster is necessary, whether or not an attribute is necessary, and an adjustment to an inter-cluster distance, and
said feedback conversion processing performs at least one from the followings:
when said feedback information indicates that a cluster is necessary, said feedback conversion processing includes generating the side-information to meet a restrictive condition which dictates that the distance between data having a characteristic attribute of the cluster is reduced;
when said feedback information indicates that a cluster is necessary, said feedback conversion processing includes generating the side-information to meet a restrictive condition which dictates that the importance degree is increased for a characteristic attribute of the cluster;
when said feedback information indicates that a cluster is not necessary, said feedback conversion processing includes generating the side-information to meet a restrictive condition which dictates that the importance degree is reduced for a characteristic attribute of the cluster:
when said feedback information indicates that the distance between clusters is adjusted, said feedback conversion processing includes generating said side-information to meet a restrictive condition which dictates that the distance between the centers of the clusters is adjusted;
when said feedback information indicates that a cluster is divided, said feedback conversion processing includes generating side-information to identify a plurality of characteristic attributes within the cluster, extract data which includes the attributes, and increase the importance degree for item of data;
when said feedback information indicates that a cluster is divided, said feedback conversion processing includes generating side-information to identify a plurality of characteristic attributes within the cluster, extract data which includes the attributes, increase the importance degree for item of data, and bring the centers of respective sets further away from each other;
when said feedback information indicates that a cluster is divided, said feedback conversion processing includes generating side-information to again cluster the cluster, and separate data within a plurality of clusters resulting from the clustering from the center thereof by a smaller distance; and
when said feedback information indicates that a cluster is divided, said feedback conversion processing includes generating side-information to again cluster the cluster, separate data within a plurality of clusters resulting from the clustering from the center thereof by a smaller distance, and space the centers apart from each other by a larger distance.

44-51. (canceled)

52. The active metric learning method according to claim 34, wherein said dimension conversion processing includes performing the dimension conversion with the use of one of the followings: a singular value resolution; a singular value resolution which imposes a constraint to bring the analysis result closer to a conversion result generated by a dimension conversion which has been executed immediately before the first dimension conversion; a non-negative matrix resolution; and a non-negative matrix resolution which imposes a constraint to bring the analysis result closer to a conversion result generated by a dimension conversion which has been executed immediately before the dimension conversion.

53-55. (canceled)

56. The active metric learning method according to claim 32, wherein for generating the metric, said metric learning processing includes one of the followings: solving a positive semi-definite value planning problem using a general library; solving a positive semi-definite value planning problem transformed on the basis of labels given to groups comprised of the data under analysis by dividing the positive semi-definite value planning problem into small problems each including a single variable case, and repeatedly executing optimization; and solving a positive semi-definite value planning problem with lower ranks given to metric parameters subjected to the metric by dividing the positive semi-definite value planning problem into small problems each including a single variable case, and repeatedly executing optimization.

57-58. (canceled)

59. The active metric learning method according to claim 37, wherein said active learning processing includes identifying the correlated attribute based on one of the followings: a correlation coefficient, a collocation score, a mutual information amount, and a conditional probability.

60-62. (canceled)

63. A computer-readable storage medium storing a computer program for causing a computer to execute:
a metric applied data analysis procedure including:
a metric application procedure that receives data under analysis having a plurality of attributes and a metric for calculating the distance between the data under analysis, and that calculates the distance between the data under analysis;
a data analysis procedure that analyzes the data under analysis with a predetermined function using the distance between the data under analysis calculated in said metric application procedure, and that outputs a data analysis result generated through the analysis; and
an metric result storage procedure that stores the data analysis result generated in said data analysis procedure; and
a metric optimization procedure including:
a feedback conversion procedure that generates side-information which presents information required for metric learning, based on instructions indicated by feedback information entered from the outside, said feedback information including similarities between the data under analysis stored through said analysis result storage procedure or the attributes or a combination thereof; and
a metric learning procedure that generates a metric that complies with a predetermined condition based on the side-information generated in said feedback conversion procedure, and that stores the generated metric through a metric learning result storage procedure,
wherein said metric application procedure calculates the distance between the data under analysis using the metric stored through said metric learning result storage procedure.

64. The computer-readable storage medium according to claim 63, further comprising an active learning procedure that actively learns the data under analysis based on the data under analysis, or data derived by applying the metric to the data under analysis, or an analysis result which is the result of analyzing the metric, or a combination thereof, and that stores the result of the active learning in an active learning storage procedure.

65-93. (canceled)
